(19) United States
(12) Patent Application Publication
(10) Pub. No.: US 2009/0059254 A1
(43) Pub. Date: Mar. 5, 2009

(54) Tint Block Image Generation Program and Tint Block Image Generation Device

(75) Inventor: Makoto Kobayashi, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/199,686

(22) Filed: Aug. 27, 2008

(30) Foreign Application Priority Data
Aug. 28, 2007 (JP) 2007-221074
Aug. 20, 2008 (JP) 2008-211321

(51) Int. Cl. G06F 15/00

(52) U.S. Cl. 358/1.9

(57) ABSTRACT

A tint block image generation program causes a computer to execute a tint block image generation step of generating tint block image data. The tint block image generation step comprises a step of acquiring camouflage pattern data that has multi-grayscales exceeding two grayscales; a step of generating corrected camouflage pattern data by correcting grayscale values of the camouflage pattern data based on input grayscale values of the latent image portion and background portion; and a step of generating latent image portion image data corresponding to the grayscale values of the corrected camouflage pattern data by referring to a latent image portion dither matrix in an area corresponding to the latent image portion, and generating background portion image data corresponding to the grayscale values by referring to a background portion dither matrix in an area corresponding to the background portion.

### CROSS-REFERENCE TO RELATED APPLICATIONS

This application is based upon and claims the benefit of priority from the prior Japanese Patent Applications No. 2007-221074, filed on Aug. 28, 2007, No. 2008-177568, filed on Jul. 8, 2008, and No. 2008-211321, filed on Aug. 20, 2008, the entire contents of which are incorporated herein by reference.

### BACKGROUND OF THE INVENTION

1. Field of the Invention

The present invention relates to a tint block image generation program and a tint block image generation device, and more particularly to a program and device for generating tint block image data to be printed on a print medium. The present invention also relates to a tint block image generation program and generation device which has an effect to inhibit forgery by copying a print medium (original) on which a tint block image is printed based on the tint block data or an effect to distinguish between the original and the copy.

2. Description of the Related Art

The tint block is combined with the original image as background, and allows distinguishing whether the print document is the original or the copy. Characters or images in the forgery inhibited tint block can hardly be identified in the original, but if copied, the characters or images in the tint block emerge. Using this, the original and the copy can easily be distinguished. Also the characters or images in the tint block emerge in copying, so if an original is generated combining with the forgery inhibited tint block, an attempt to copy the original is psychologically discouraged.

The tint block is disclosed in Japanese Patent Application Laid-Open No. 2005-151456, and details follow according to this description.

Generally a tint block is comprised of two areas: a “latent image portion” where dots printed in the original remain or decrease little by copying, and a “background portion” where dots printed in the original are lost or greatly decreased by copying. In other words, in the latent image portion, density changes little by copying, and the original image is reproduced as is, and in the background portion, density changes considerably by copying, and the original image disappears. The characters or images of the tint block are generated by these two areas, and the characters and images of the tint block are called the “latent image”.

The densities of the latent image portion and the background portion are roughly the same, and in the original state, it is visually difficult to find such characters or images as “COPIED” of Japanese character are concealed in the tint block, but at the micro level, the background portion and latent image portion have different characteristics. When the tint block is copied, a density difference is generated between the latent image portion and the background portion, because of the difference of the respective change of density, which makes it easier to discern the characters or images of the tint block created by these two areas.

The latent image portion is comprised of clustered dots so that dots can be easily read when copying (scanning by copying), whereas the background portion is comprised of dispersed dots so that dots cannot be easily read when copying. By this, dots tend to remain in the latent image after copying, and dots tend to disappear in the background portion more easily than the latent image portion. Clustered dots or dispersed dots can be implemented by half tone processing using a different number of lines of half tone dots. In other words, half tone dots of which screen ruling is low are used to obtain a clustered dot arrangement, and half tone dots of which screen ruling is high are used to obtain a dispersed lot arrangement.

Generally a copier has a limitation in image reproducing capability, which depends on the input resolution in a step of reading the micro dots of a copy target original by a scanner, and the output resolution in a step of reproducing micro dots, read by the scanner, using a print engine. Therefore if isolated micro dots exist in the original, exceeding the limitation of the image reproducing capability of the copier, the micro dots cannot be perfectly reproduced in a copy, and the portions of the isolated micro dots disappear. In other words, if the background portion of the tint block is created so as to exceed the limitation of the dots that the copier can reproduce, then large dots (clustered dots) in the forgery inhibited tint block can be reproduced by copying, but small dots (dispersed dots) cannot be reproduced by copying, and a concealed latent image appears in the copy. Even if the dispersed dots in the background portion do not disappear completely by copying, a density difference is generated between the background portion and the latent image portion after copying if the degree of loss of dots is high, compared with the clustered dots in the latent image portion, then a concealed latent image appears in the copy.

In the tint block, a technology called “camouflage” is used to make it more difficult to discern characters or images concealed as a latent image. This camouflage technology is a method for arranging patterns, of which density is different from the latent image portion and the background portion, in the entire tint block image, and in a macro view, the camouflage patterns, of which density is different from the latent image portion and the background portion, standout, making the latent image even more obscure. In other words, the contrast of the camouflage patterns is high, and the contrast of the latent image portion and the background portion is smaller than this, so the latent image is more effectively concealed because of optical illusion. Also the camouflage pattern can give a decorative impression on printed matter, and allows creating an artistically designed tint block. Generally a camouflage pattern is created in binary, and the camouflage pattern is formed by not generating dots of the tint block in an area corresponding to the camouflage pattern. The camouflage pattern with two grayscales is disclosed in Japanese Patent Application Laid-Open No. H04-170569. The above is an overview of the tint block.

FIG. 1 shows an example of a latent image of a tint block and a camouflage pattern. In a latent image mask pattern 10 of the Japanese character “COPY”, the black portion corresponds to the latent image portion LI of the tint block, and the white portion corresponds to the background portion BI of the tint block, for example, as the enlarged view 10X shows. In the camouflage pattern 12, on the other hand, the black portion CAM becomes an area where the dots of the tint block are not formed, and the white portion becomes an area where dots of the tint block are formed, for example, as the enlarged view 12X shows. In other words, the data of the camouflage pattern is binary image data where each pixel indicates a portion to print the tint block image and a portion not to be printed.

FIG. 2 is a diagram depicting an example of an original in which a tint block is printed. In the tint block 14, a latent image portion LI and a background portion BI are formed based on the latent image mask pattern 10 in FIG. 1. The latent image portion LI is formed by dots with low screen ruling (53 lpi) based on a clustered dot dither method, and the background portion BI is formed of dots with high screen ruling (212 lpi) based on the dispersed dot dither method. As the enlarged tint block 14X shows, the entire tint block has a predetermined output density, but the dots in the latent image portion LI are large dots formed by a screen with low screen ruling, and the dots in the background portion BI are small dots formed by a screen with high screen ruling.

In the tint block 16, the latent image portion LI and the background portion BI are formed, excluding a black area CAM of the camouflage pattern, based on the latent image mask pattern 10 and the camouflage pattern 12 in FIG. 1. As the enlarged tint block 16X shows, the entire tint block has a predetermined output density, where dots are not formed in the area CAM of the camouflage pattern, and in another area, the latent image portion LI formed by large dots and the background portion BI formed by micro dots are formed just like FIG. 1. Since the contrast of the camouflage pattern is high, the latent image (the Japanese character “COPY”), comprised of the latent image portion LI and the background portion BI, of which contrast is low, does not stand out.

In the original of the forgery inhibited tint block in FIG. 2, the output density of the latent image portion LI and the background portion BI are the same, whereby the latent image of the Japanese character “COPY” formed by these portions is concealed. This is referred to as the “concealment capability for a latent image in the original is high”.

FIG. 3 is a diagram depicting an example of a copy of the forgery inhibited tint block. The copy 18 is created via a scanning step and dot generation step (step of printing the print media based on the scan data generated in the scanning step) by copying, and as the enlarged view 18X shows, large dots in the latent image portion LI are hardly lost, but many micro dots in the background portion BI are lost. As a result, in the copy 18, the output density of the latent image LI hardly drop, but the output density of the background portion BI drop considerably, and the latent image of the Japanese character “COPY” emerges. In other words, the latent image of the copy is more easily identified.

The copy 20 is the same as the copy 18, except for the area CAM of the camouflage pattern. The contrast of the camouflage pattern drops because of the drop in the output density of the background portion BI, and the latent image COPY emerges.

FIG. 4 are diagrams further enlarging the enlarged view of the original in FIG. 2 and the enlarged view in the copy in FIG. 3. In the original shown in (a), the latent image portion LI is formed by dots (halftones), with low screen ruling and a large area, and the background portion BI is formed by micro dots with high screen ruling. No dots are formed in a black portion CAM of the camouflage pattern. In the copy (b), on the other hand, the size of the large dots (halftones) in the latent image portion LI do not change much, but a considerable number of micro dots in the background portion BI are lost. As a result, in the copy, the output density of the latent image portion LI hardly drops, while the output density of the background portion BI drops considerably where the latent image “COPY” of the tint block emerges clearly.

### SUMMARY OF THE INVENTION

As mentioned above, implementing both high concealment capability for the latent image in the original and high identification capability for a latent image in the copy is demanded for tint blocks. Adding a camouflage pattern can improve the concealment capability in the original, and provide a decorative image to the printed matter, making the tint block design artistic.

However a first problem is that a camouflage pattern formed by binary information, whether dots are generated or not, on the tint block is poor in the artistic expression of a pattern. A second problem is that in the case of the tint block with camouflage pattern 16 in FIG. 2, the contrast of the camouflage pattern is high, and it is difficult to discern the latent image, which is good for improving the concealing capability in the original, but contrast is so strong that the camouflage pattern stands out too much when the original image (printed document image) is combined. A third problem is that identification capability for the latent image is lower in the copy 20, which has a camouflage pattern in FIG. 3, than in the copy 18 which does not have a camouflage pattern, since dots are not formed in areas CAM which correspond to the camouflage pattern in the latent image “COPY” in the copy 20. In other words, the presence of the camouflage pattern drops the identification capability for the latent image in the copy.

As mentioned above, it is demanded to prevent a drop in document discerning capability in the original, and to prevent a drop in latent image identification capability in the copy when a camouflage pattern formed by binary information is used. It is also demanded to improve the capability of artistic expression of camouflage patterns.

With the foregoing in view, it is an object of the present invention to provide a program and a device for generating a tint block with which design flexibility of a camouflage pattern is increased.

It is another object of the present invention to provide a program and device for generating a tint block with a camouflage pattern, which can prevent a drop in discerning capability for an original print document while maintaining the concealing capability for a latent image in an original.

It is still another object of the present invention to provide a program and a device for generating a tint block with a camouflage pattern which can prevent a drop in identification capability for a latent image in the copy.

To achieve the above object, a first aspect of present invention provides a computer-readable medium which stores a tint block image generation program for causing a computer to execute a tint block image generation step of generating tint block image data which forms, on a print medium, a tint block image including a latent image portion and a background portion, having different output densities to be reproduced during copying, and the tint block image generation step comprises:

a first step of acquiring camouflage pattern data that has multi-grayscales exceeding two grayscales;

a second step of generating corrected camouflage pattern data by correcting grayscale values of the camouflage pattern data based on input grayscale values of the latent image portion and background portion; and

a third step of generating latent image portion image data corresponding to the grayscale values of the corrected camouflage pattern data by referring to a latent image portion dither matrix in an area corresponding to the latent image portion, and generating background portion image data corresponding to the grayscale values by referring to a background portion dither matrix in an area corresponding to the background portion.

In the first aspect, it is preferable that the latent image portion image data and background portion image data which are generated by referring to the latent image portion dither matrix and background portion dither matrix in the third step, respectively, are image data to reproduce a multi-grayscale latent image portion image and a multi-grayscale background portion image, respectively.

In the first aspect, it is preferable that the latent image portion image data is image data for forming a plurality of first dots in positions corresponding to the grayscale values of the corrected camouflage pattern data, the background portion image data is image data for forming a plurality of second dots in positions corresponding to the grayscale values of the corrected camouflage pattern data, and the latent image portion dither matrix is a dot-clustered dither matrix where dots are clustered in the center of the first dots, and the background portion dither matrix is a dot-dispersed dither matrix where the second dots are dispersed.

In the first aspect, it is preferable that characteristics of output densities with respect to a possible range of the grayscale values match between the latent image portion dither matrix and background portion dither matrix, and the input grayscale values of the latent image portion and background portion are the same.

In the first aspect, it is preferable that the multi-grayscale camouflage pattern data has grayscale data of a plurality of colors, and in the first step, the grayscale values of the camouflage pattern data are grayscale values which are determined based on the grayscale values of the plurality of colors.

A second aspect of the present invention provides a computer-readable medium which stores a tint block image generation program for causing a computer to execute a tint block image generation step of generating tint block image data which forms, on a print medium, a tint block image including a latent image portion and a background portion, having different output densities to be reproduced during copying, and the tint block image generation step comprises:

a step of acquiring camouflage pattern data that has multi-grayscales exceeding two grayscales; and

a step of generating latent image portion image data corresponding to grayscale values of the camouflage pattern data by referring to a latent image portion dither matrix in an area corresponding to the latent image portion, and generating background portion image data corresponding to the grayscale values by referring to a background portion dither matrix in an area corresponding to the background portion, and wherein

characteristics of output densities with respect to a possible range of input grayscale values match between the latent image portion dither matrix and background portion dither matrix, and the grayscale values of the latent image portion and background portion are set to the maximum input grayscale value out of the possible range of the input grayscale values of the latent image portion dither matrix and background portion dither matrix.

A third aspect of the present invention provides a tint block image generation device according to the first or second aspect.

### BRIEF DESCRIPTION OF THE DRAWINGS

FIG. 1 is a diagram depicting an example of a latent image of a tint block and a camouflage pattern;

FIG. 2 is a diagram depicting an example of an original of a tint block;

FIG. 3 is a diagram depicting an example of a copy of a tint block;

FIG. 4 are diagrams further enlarging the enlarged view of the original in FIG. 2 and the enlarged view of the copy in FIG. 3;

FIG. 5 is a diagram depicting a configuration of a tint block image generation device according to the present embodiment;

FIG. 6 is a flow chart depicting a tint block data generation procedure according to the present embodiment;

FIG. 7 shows an example of dither matrices for generating images of a background portion BI and a latent image portion LI of a tint block;

FIG. 8 shows an input grayscale and an output density characteristic of a background portion basic dither matrix DM-BI and a latent image portion basic dither matrix DM-LI;

FIG. 9 shows output density characteristics with respect to the input grayscale value of the background portion basic dither matrix and the latent image portion dither matrix according to the first embodiment;

FIG. 10 shows a low density area expanded dither matrix 33 for the latent portion used for the present embodiment;

FIG. 11 shows a low density area expanded dither matrix 34 for the background portion used for the present embodiment;

FIG. 12 shows an output density characteristic with respect to the input grayscale value of the latent image portion dither matrix 33 and the background portion dither matrix 34;

FIG. 13 is a flow chart depicting a tint block image data generation method according to the present embodiment;

FIG. 14 shows examples of the tint block effect;

FIG. 15 shows examples of a tint block arrangement;

FIG. 16 shows an example of a camouflage pattern and an example of a tint block image using this camouflage pattern;

FIG. 17 shows examples of camouflage patterns stored in a memory;

FIG. 18 is a flow chart depicting the tint block image generation processing according to the present embodiment;

FIG. 19 shows a normalized background portion dither matrix 34N;

FIG. 20 shows the input-output density characteristics of the normalized background portion dither matrix, the background portion dither matrix before normalization, and the latent image portion dither matrix;

FIG. 21 describes the tint block image generation processing in FIG. 18;

FIG. 22 shows an example of a latent image mask pattern;

FIG. 23 shows an example of a camouflage pattern;

FIG. 24 shows an example of a corrected camouflage pattern;

FIG. 25 shows an example of a tint block image with a camouflage pattern;

FIG. 26 shows an example of a tint block image in the case of a conventional two-grayscale camouflage pattern;

FIG. 27 shows the input-output density characteristics of a background portion dither matrix and a normalized latent image portion dither matrix according to a variant form of the present embodiment;

FIG. 28 shows an experiment example of a multi-grayscale camouflage pattern;

FIG. 29 shows an experiment example of an original and copy of the tint block image where the multi-grayscale camouflage pattern in FIG. 28 is reflected; and

FIG. 30 are diagrams further enlarging the enlarged views 14X and 16X in FIG. 29.

### DESCRIPTION OF THE PREFERRED EMBODIMENTS

Embodiments of the present invention will now be described with reference to the drawings. The technical scope of the present invention, however, shall not be limited to these embodiments, but extend to matters stated in the Claims and equivalents thereof.

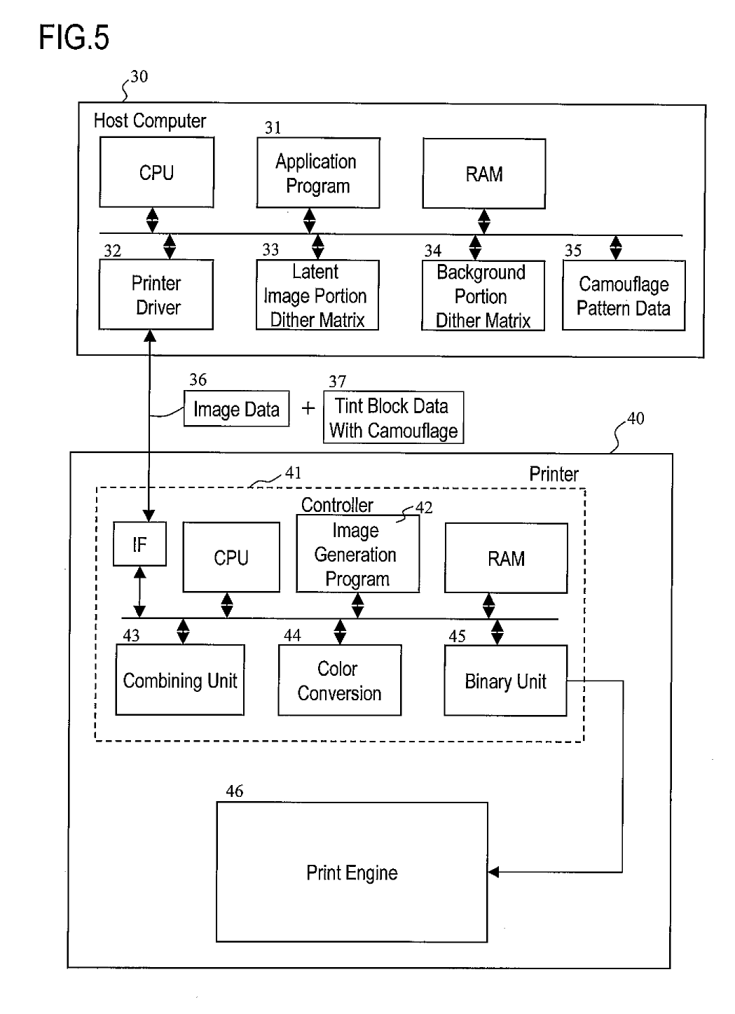

FIG. 5 is a diagram depicting a configuration of a tint block image generation device according to the present embodiment. The tint block image generation device comprises a printer driver program 32, a latent image portion dither matrix 33, a background portion dither matrix 34, a camouflage pattern data 35 which are installed in a host computer 30, and a printer 40. The latent image portion dither matrix 33 and the background dither matrix 34 are included in a printer driver program 32, which the printer manufacturer distributes to users via a recording media or via such a network as the Internet, and are stored in a recording media in the host computer when the printer driver program 32 is installed in the host computer. The host computer 30 further comprises a CPU, a RAM and an application program 31, and generates image data comprised of text, images and graphics, by executing the application program 31.

The host computer 30 also generates tint block data with camouflage pattern 37 using the printer driver 32 in response to a request from user. When a print request is received from the user for the image data generated by the application 31, the printer driver generates a print job of the printing target image data 36 based on a printer control language which the printer device 40 can interpret. If the print request from the user includes a request to add the tint block data to the printing target image data 36, then the printer driver 32 generates the tint block data, includes the tint block data 37 in the print job, and sends this data to the interface IF of the printer 40.

The image data 36 could take various forms, such as data described by a page description language, data developed into intermediate code of a printer, and RGB bit map data developed into pixels. The tint block data with camouflage pattern 37 is image data generated by screen-processing the grayscale data of a multi-grayscale camouflage pattern corrected (or modulated) by input grayscales of the tint block using the dither matrices 33 and 34. According to the present embodiment, the camouflage pattern has a multi-grayscale (three or more grayscales), and the grayscale data of the camouflage pattern is 3-bit or more binary data. The tint block data 37 is data to indicate the ON/OFF of dots of each pixel, for example. The ON/OFF of the tint block data is represented by binary values, 0 and 1, for each pixel, for example. If the print target image data is represented by an 8-bit grayscale value for each color, R, G and B, then the ON/OFF of the dots of the tint block data may be represented by 8 bits for each pixel, where ON is a value corresponding to the maximum grayscale value 255, and OFF is a value corresponding to the minimum grayscale value 0.

The printer 40, on the other hand, comprises a print engine 46, which comprises a print medium providing unit, a print execution unit for generating an image on a print medium, and a print medium discharge unit, and a controller 41 for performing a predetermined image processing on a received image data 36 and tint block data 37, and controlling the print engine 42. A CPU of the controller 41 executes an image generation program 42 and generates bit map data by developing the received image data 36 into pixels. If the received image data 36 is already in bit map data format, this bit map data can be directly used.

A combining unit 43 combines bit map data which has a grayscale value for each pixel of the image data 36, and dot data of the tint block data 37. The combining process is a superimposing an image of tint block data 37 with an image of the image data 35 for example. A color conversion unit 44 converts the color of combined RGB data into CMYK data, a binary unit 45 converts the CMYK bit map data into a data of dots in a pixel using a predetermined screen, and outputs the result to the print engine 46. As a result, the print engine 46 prints a combined image of the image generated by the application program and the tint block image on the print media. This is the original.

According to another combining method, before combining the bit map data of the image data 36 and the tint block image data, the color of RGB bit map data of the image data 36 is converted into CMYK bit map data, and the tint block data 37 is combined with a bit map data having any one color of CMYK. In this case, the dot ON/OFF information for each pixel of the tint block data 37 is used as the maximum grayscale value/minimum grayscale value of the bit map data, and this bit map data of any one color of CMYK of the image data 36 is overwritten by this tint block 37. For example, if the image data 36 is text data of black K, the bit map data of any one color of CMY is converted into tint block data 37. Or the pixels of which grayscale value is the minimum density of the bit map data of any one color of the image data 36 is overwritten by the tint block data 37.

In the embodiment in FIG. 5, the printer driver 32 of the host computer 30 corresponds to the tint block image generation program, and generates the tint block data 37. As a variant form, the tint block data and camouflage pattern data may be generated in the printer, so that the tint block image is generated based on this data. In this case, the printer driver 32 generates a print job data, including the specifications of combining the tint block image with the print target image data 36, and printing the combined image, and the controller 41 of the printer 40 executes the tint block image generation program, and generates the tint block data with a camouflage pattern from the print job data, using the latent image portion dither matrix and the background portion dither matrix stored in the printer 40. The print job data for tint block generation is data including information required to generate the tint block data with a camouflage pattern, such as the specifications of characters and patterns which are lost or reproduced during copying, the specifications of the density of the tint block, and the specifications of a camouflage pattern. The tint block generation processing in the printer 40 may be performed by the CPU of the printer executing an image generation program, or by being executed in such a dedicated image processing generation device that is ASIC-based.

### [Overview of Tint Block Generation Procedure]

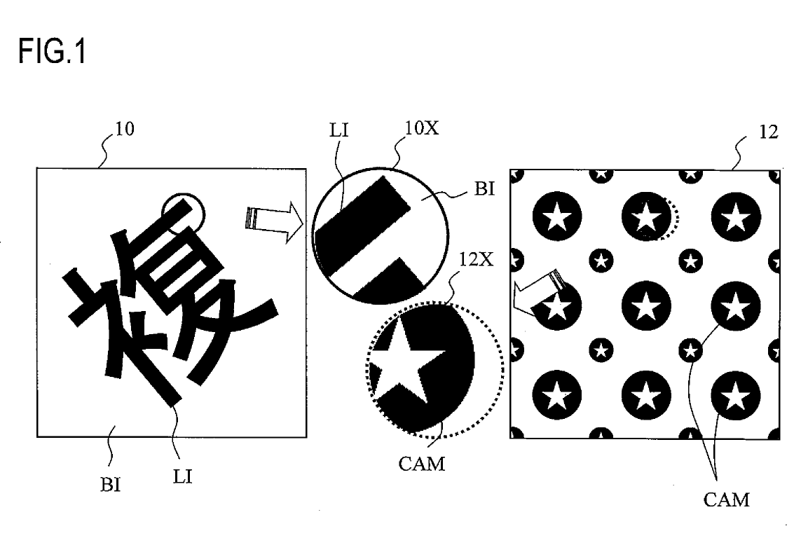

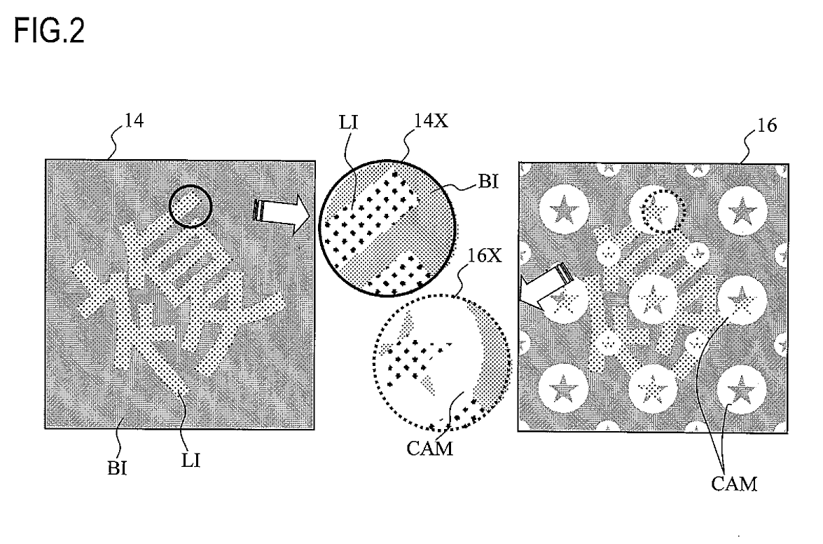

The tint block generation method by the tint block image generation device according to the present embodiment will now be described in brief. The tint block image generation device is a host computer, in the case of the tint block image being generated by the printer driver 32, or the printer 40, in the case of the tint block image being generated by the image generation program 42. In the present embodiment, just like FIG. 1 and FIG. 2, the tint block image generation device generates tint block image data comprised of a latent image portion and a background portion, corresponding to a latent image mask pattern which the user selected from default patterns, or a latent image mask pattern which the user originally generated.

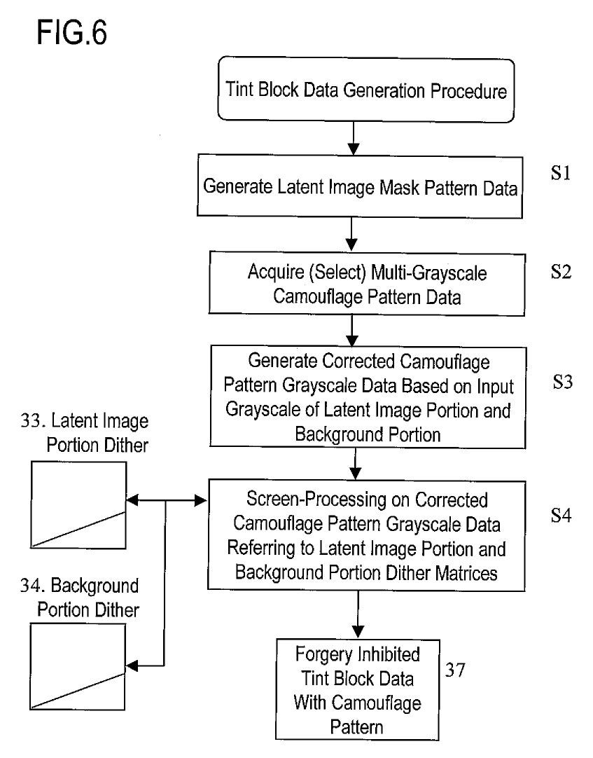

FIG. 6 is a flow chart depicting the tint block data generation procedure according to the present embodiment. The tint block image generation device generates latent image mask pattern data (S1). The latent image mask pattern data is data on the latent mask pattern 10, that is, the character “COPY” shown in FIG. 1, and each pixel is comprised of data, 0 or 1, which indicates a latent image portion LI or a background portion BI. The tint block image generation device acquires multi-grayscale camouflage pattern data (S2). The camouflage pattern data is multi-grayscale image data, such as photograph data and image data, acquired by the user, or data selected from a plurality of camouflage pattern data 35 stored in a memory of a host computer 30 in advance. The multi-grayscale camouflage pattern data has 8-bit grayscale data, for example, for each pixel, and this camouflage pattern can represent 256 grayscales, exceeding two grayscales. By using a multi-grayscale camouflage pattern, a drop in identification capability for a print target print document image in the original can be suppressed, and a drop in identification capability for latent images in the copy can also be suppressed. Since a multi-grayscale camouflage pattern can be used, printed matter which excels in design can be created.

The camouflage pattern data according to the present embodiment is 8-bit (0: black to 255: white) grayscale value data for each pixel, and is grayscale image data represented by 256 grayscales. The output density of the camouflage pattern is lower as the grayscale becomes closer to 0 (black), and is higher as the grayscale becomes closer to 255 (white). The output density DA of the tint block, which is output with respect to the grayscale value A (A=0 to 255) of the camouflage pattern is

DA=(A/255)×Dmax(0≦A≦255) (1)

where Dmax is the output density of the tint block in the case of no adding the camouflage pattern.

Therefore when the grayscale values of a camouflage pattern are all white (A=255), the output density DA of the tint block with a camouflage pattern becomes DA=Dmax, that is, the same output density as a tint block without a camouflage pattern. In other words, the output becomes the same as the output of the area other than the pattern CAM in 16 of FIG. 2. As the grayscale value of the camouflage pattern becomes closer to 255 (white), the decrease amount of the output density Dmax of the tint block decreases. Whereas as the grayscale value of the camouflage pattern becomes closer to 0 (black), the decrease amount of the output density Dmax of the tint block increases. And when the grayscale values of the camouflage pattern are all black (A=0), the output density DA of the tint block with a camouflage pattern becomes DA=0, and no dots are formed in the tint block. In other words, the output becomes the output of the pattern CAM in 16 of FIG. 2.

As mentioned above, if the multi-grayscale camouflage pattern is used, the multi-grayscale camouflage pattern can be combined with the latent image portion and background portion of the tint block, and compared with 1-bit camouflage pattern data, the contrast of the camouflage pattern can be decreased.

In order to reflect the above camouflage pattern in the tint block, the tint block image generation device generates the corrected camouflage pattern grayscale data based on the input grayscales of the latent image portion and background portion (S3). The input grayscales of the latent image portion and background portion correspond to the output density of the tint block image, and are grayscale values determined by default, or grayscale values corresponding to the output density of the tint block image which the user selected arbitrarily. As the above Expression (1) shows, the tint block image with a camouflage pattern is an image generated by modulating the tint block image comprised of the latent image portion and background portion, with the grayscale values of the multi-grayscales camouflage pattern. In other words, the tint block image with a camouflage pattern is an image generated by modulating the grayscale values of the multi-grayscale camouflage pattern with the input grayscales of the tint block image. The procedure S3 is a procedure to generate the camouflage pattern grayscale data by performing this modulation processing, and the corrected camouflage pattern grayscale data is the modulated grayscale data.

Finally, the tint block image generation device screen-processes the corrected camouflage pattern grayscale data, by referring to the latest image portion dither matrix 33 or the background portion dither matrix 34, according to the latent image mask pattern data, and generates the tint block data with camouflage pattern 37 (S4). In other words, the tint block image data is generated referring to the latent image portion dither matrix 33 in an area corresponding to the latent image portion, and the tint block image data is generated referring to the background portion dither matrix 34 in an area corresponding to the background portion.

The latent image portion dither matrix 33 and background portion dither matrix 34 are a threshold matrix or a grayscale conversion matrix, for example, which are both dither matrices that can be converted into multi-grayscale image data. The dither matrices 33 and 34 may be an AM screen, which represents multi-grayscales by a dot area, or may be an FM screen, which represents multi-grayscales by a dot density. However, the output density to be reproduced in copying must be different between the latent image portion and background portion as an original function of the tint block image, so the screen to be used must implement this function. For example, the screen ruling is different between the latent image portion dither matrix 33 and the background portion dither matrix 34. Or the latent image portion dither matrix 33 and the background portion dither matrix 34 are the dot clustered matrix and dot dispersed matrix respectively.

Now a procedure to generate tint block data with a camouflage pattern according to the present embodiment will be described.

### [Latent Image Portion Dither Matrix and Background Portion Dither Matrix]

The latent image portion is generated to be an image with a predetermined output density by a plurality of first dots using the latent portion image dither matrix 33. The background portion, on the other hand, is formed to be an image with a predetermined output density by a plurality of second dots using the background portion dither matrix 34. In order to increase the latent image concealing capability in the original, it is preferable that the latent image portion and background portion become images which have a similar output density.

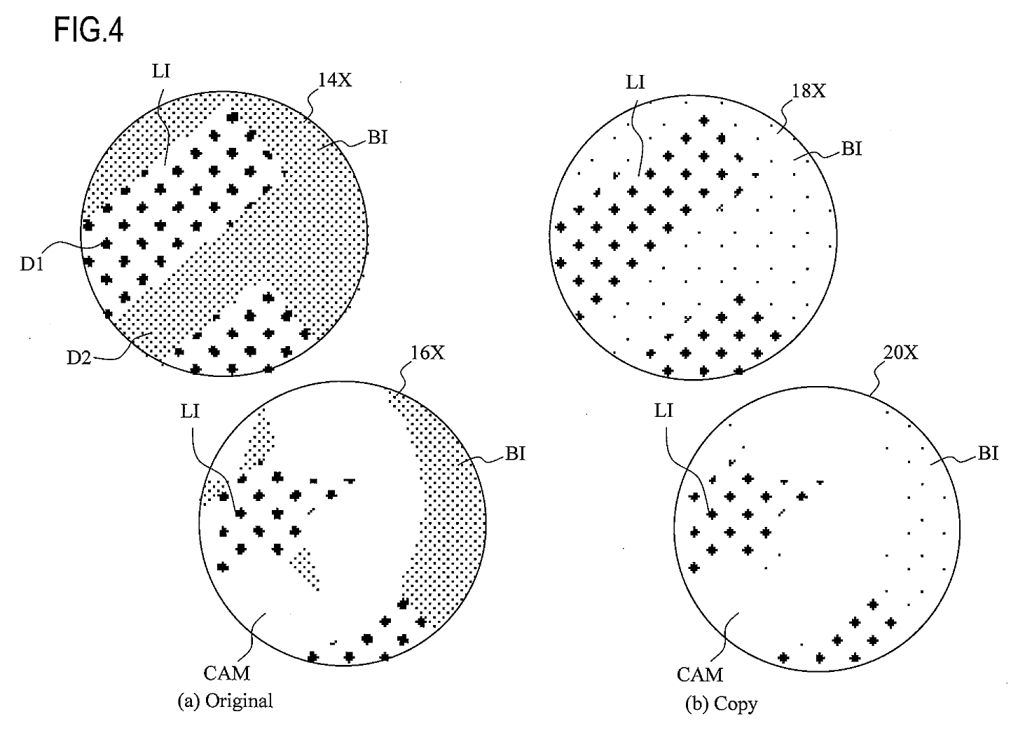

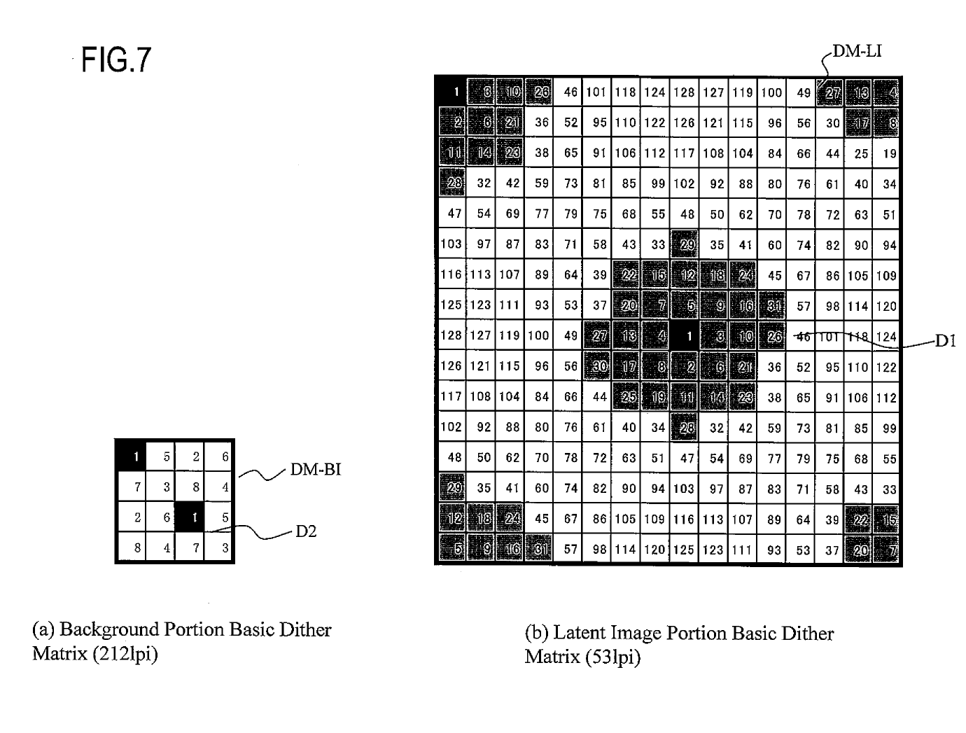

FIG. 7 shows an example of dither matrices for generating images of the background portion BI and the latent image portion LI of the tint block. The background portion basic dither matrix DM-BI in FIG. 7A is a dot dispersed dither matrix where each element of the 4×4 matrix has a threshold of 1 to 8. Threshold “1” is assigned to elements at positions of the displacement vectors (−2, 2) and (2, 2), threshold “2” is assigned at positions distant from the elements with threshold “1”, and thresholds “3 to 8” are arranged there between. In the tint block image generation step, the input grayscale value of the background portion and the threshold of each element of the background portion basic dither matrix DM-BI are compared, and if the input grayscale value is the threshold or more, a dot is formed in the pixel. For the background portion basic dither matrix DM-BI in FIG. 7A, the input grayscale value is set to “1”, and the second dot D2 is formed at a position of the black pixel which has threshold “1”. The enlarged view of this is shown in the background portion BI of FIG. 4A, and in the background portion BI, micro dots D2 are formed with screen ruling 212 lpi.

The latent image portion basic dither matrix DM-LI in FIG. 7B, on the other hand, is a dot clustered dither matrix, where each element of a 32×32 matrix has a threshold of 1 to 128. Threshold “1” is assigned to elements at positions of the displacement vectors (−8, 8) and (8, 8), which correspond to the center position of a first dot (halftones) D1. Thresholds “2 to 128” are sequentially distributed from a pixel with a threshold of “1”, which corresponds to the center position of the first dot (halftones) D1. In the tint block image generation step, the input grayscale value of the latent image portion and threshold of each pixel of the latent image portion basic dither matrix DM-LI are compared, and a dot is formed in the pixel if the input grayscale value is the threshold or more. In the latent image portion basic dither matrix DM-LI in FIG. 7B, the input grayscale value “31” is set, and a dot is formed at a position of an element which has a threshold of “1 to 13”, whereby a large dot (halftones) D1 is formed. The enlarged view of this is shown in the latent image portion LI of FIG. 4A, and large dots D1 are formed with a screen ruling of 53 lpi.

As mentioned above, in the original, the tint block is demanded to keep concealment capability for the latent image high by equalizing output densities of the background portion and latent image portion. In the copy, it is demanded to increase the identification capability for the latent image by increasing the difference of output densities between the background portion and latent image portion, and increasing the output density of the latent image portion. The first dot D1, which is large, hardly disappears in the copy, but the second dot D2, which is small, easily disappears in the copy. Thereby the output densities during copying differs between the latent image portion and background portion.

However, in the image generated by the dither matrices DM-BI and DM-LI in FIG. 7, the number of grayscales (resolution) of the output density is limited in a low output density area used for a tint block, such as an area of which output density is 10 to 15%. In the case of the background portion basic dither matrix DM-BI, a micro dot D2 is formed at a position which has threshold “1”, so the background portion is generated with an output density corresponding to this micro dot formation. Whereas in the case of the latent image portion generation step, an input grayscale value that can generate the output density which is the same as the output density of the background portion is selected, and the image in the latent image portion is generated by comparing this input grayscale value with the latent image portion basic dither matrix DM-LI. However, the number of grayscales (resolution) of the output density of the latent image portion LI is limited, as mentioned above, so in some cases, the latent image portion LI may not be generated with an output density matching the output density of the background portion.

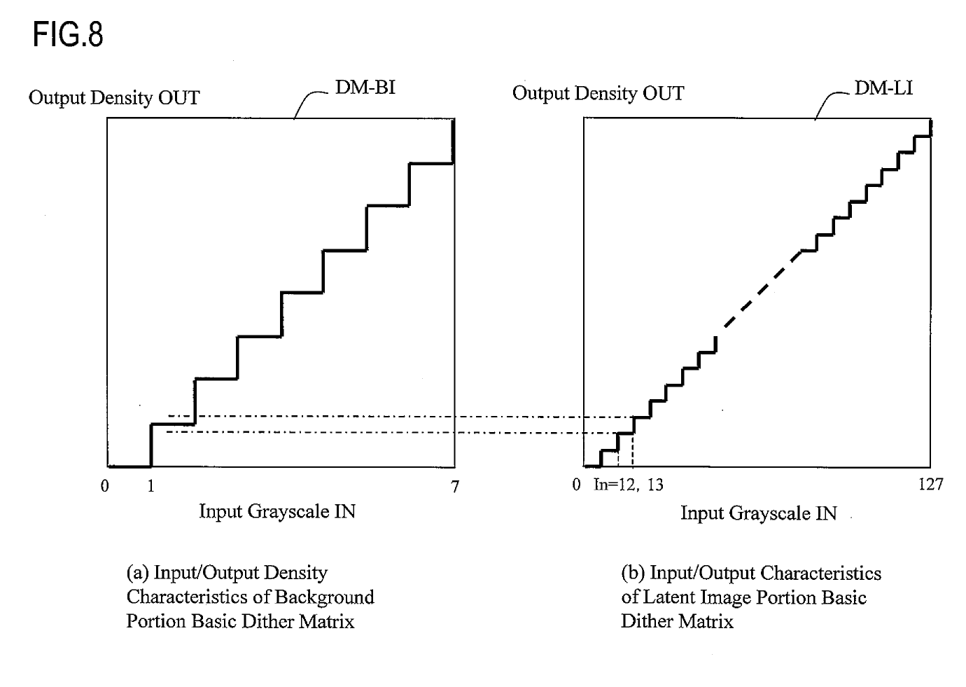

FIG. 8 shows the characteristics of the input grayscale and output density of the background portion basic dither matrix DM-BI and the latent image portion basic dither matrix DM-LI. The characteristics shown in FIG. 8 are based on the assumption that the number of dots generated in a pixel, of which threshold is less than the input grayscale value, and the output density of the tint block image generated by the printer engine, are in an ideal linear relationship in the basic dither matrix, to simplify description.

When the tint block image generation device uses the latent image portion basic dither matrix DM-LI shown in FIG. 7B as the latent image portion dither matrix 33 and the background portion basic dither matrix DM-BI shown in FIG. 7A as the background portion dither matrix 34, the characteristics of the input grayscale value and the output density of the corresponding latent image portion image data and background portion image data are as shown in FIG. 8. In other words, in the case of the background portion, the output density OUT with respect to the input grayscale value In=0 to 7 may possibly be one of 8 output density values, including “0”. This means that the number of grayscales (or resolution) of the output density, from white, where all pixels dots are OFF, to the maximum output density, where all pixel dots are ON, is 8. And as shown in FIG. 7A, in the background portion, micro second dots D2 are dispersed in positions of pixels having threshold “1” of the dither matrix DM-BI with respect to the input grayscale value In=1. Whereas in the case of a latent image portion, the output density OUT may possibly be one of 128 output density values, including “0”, with respect to the input grayscale value In=0 to 127. This means that the number of grayscales (or resolution) of the output density, from white to the maximum output density, is 128.

However, the output density corresponding to the input grayscale In=1 in the background portion is between two output densities corresponding to the input grayscales In=12 and 13 in the latent image portion. Therefore, it is not possible to make the output densities of the background portion and latent image portion the same.

The output density range that can be used as the tint block image is 10 to 15% of the maximum output density. In the range of the output density 10 to 15%, the number of grayscales of the output density that can be reproduced by the latent image portion basic dither matrix is at most 20. Since the change of the output densities that can be adjusted by changing one step of the input grayscale value of the latent image portion becomes greater than a predetermined value, it is difficult or impossible to match the output density of the latent image portion with the output density of the background portion at high precision, even if the screen ruling of the latent image portion dither matrix is increased, and the number of grayscales of the output density of the latent image portion is increased.

Even if the change of the output density of the tint block image is enabled within a 10 to 15% range by doubling or quadrupling the size of the background portion basic dither matrix, and increasing the number of grayscales of the output density of the background portion, it is still difficult or impossible to match the output density of the background portion and the output density of the latent image portion at high precision due to reasons similar to above.

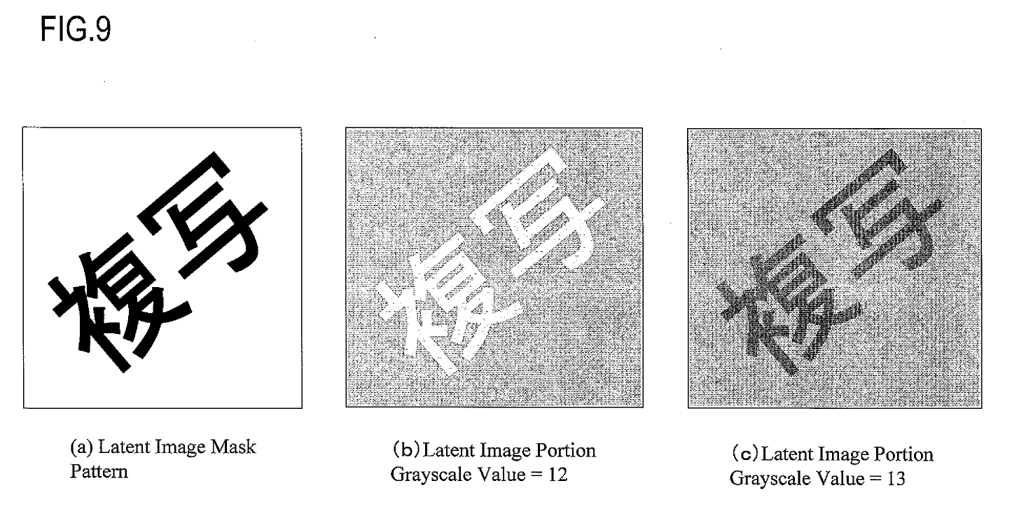

FIG. 9 shows an example when the concealment capability for the latent image in the original deteriorates. FIG. 9B shows a tint block image when the input grayscale value of the latent image portion is set to “12” in the latent image mask pattern “COPIED” in FIG. 9A, and FIG. 9C shows a tint block image when the input grayscale value of the latent image portion is set to “13”. In FIG. 9B, the output density of the latent image mask pattern is lower than the background portion, therefore the concealment capability for the latent image “COPIED” has dropped. In FIG. 9C, the output density of the latent image mask pattern is higher than the background portion, therefore the concealment capability for the latent image “COPIED” has also dropped.

Therefore in the present embodiment, for the background portion dither matrix and latent image portion dither matrix, the dither matrices which are generated based on the basic dither matrix in FIG. 7, and have characteristics where the output density increases within a low density area, such as 0 to 15%, with respect to the input grayscale value 0 to 255, are used.

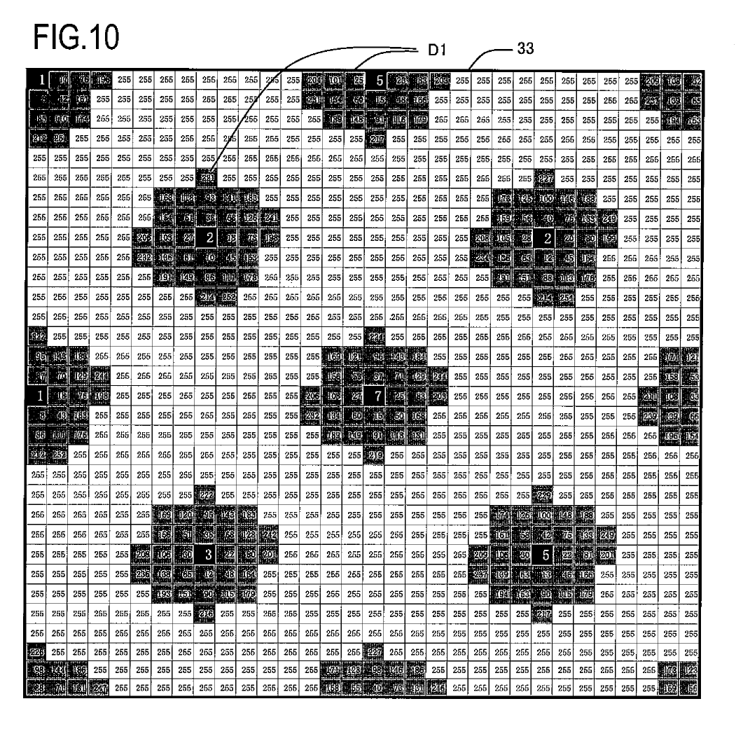

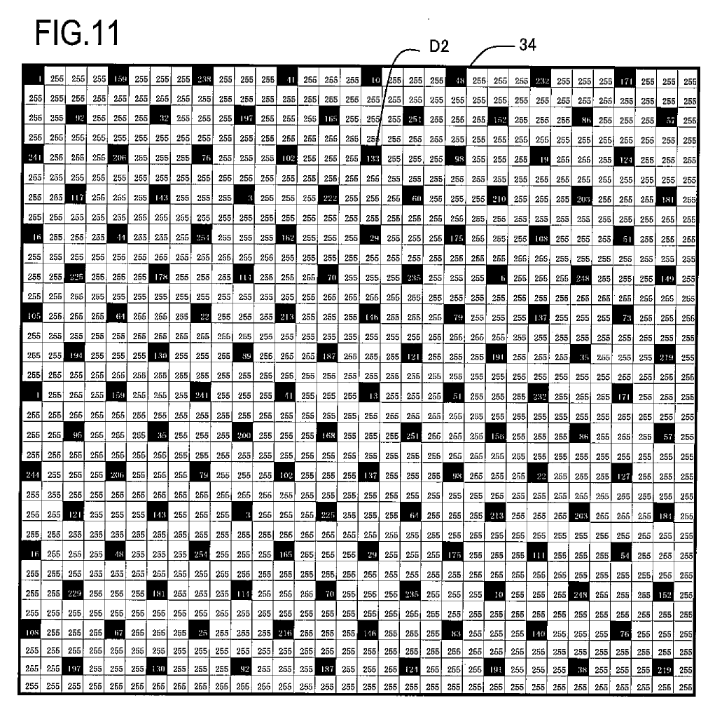

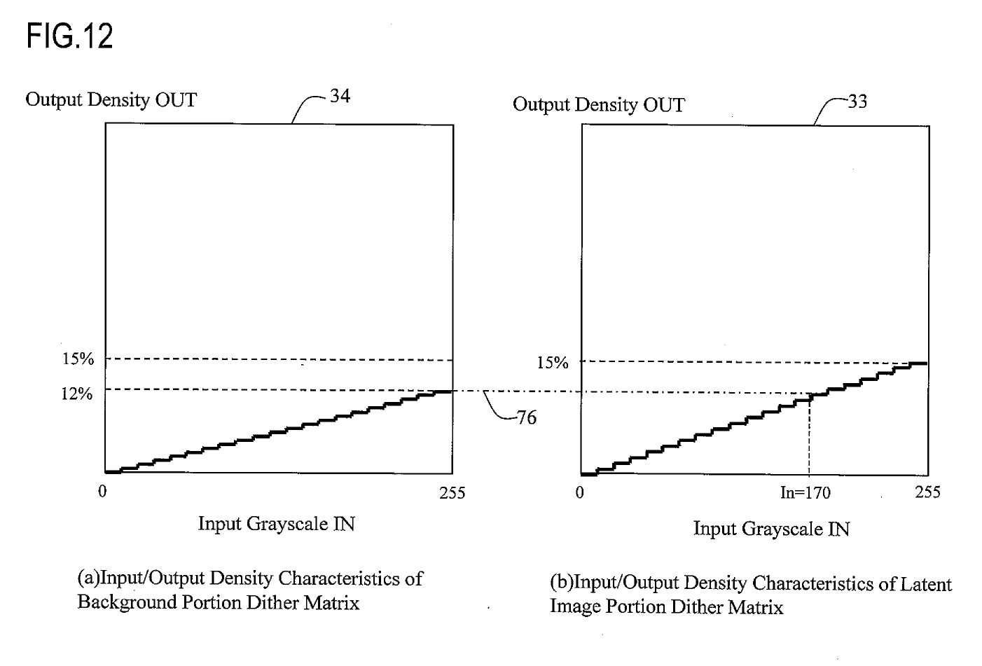

FIG. 10 and FIG. 11 show the latent image portion dither matrix 33 in which a low density area is expanded, and the background portion dither matrix 34 in which a low density area is expanded. FIG. 12 shows the output density characteristics of the latent image portion dither matrix 33 and background portion dither matrix 34 with respect to the input grayscale values.

In order to generate the dither matrix 33 34, the sizes of the basic dither matrices DM-BI and DM-LI in FIG. 7 are expanded until the number of grayscales becomes sufficient. For example, the matrix size is expanded to 128×128. In FIG. 10 and FIG. 11, however, a matrix size of 32×32 is shown for convenience. Then all thresholds of the expanded dither matrix are dispersed and diffused so that all thresholds are different in the sequence of dot generation, corresponding to the increase in the input grayscale value. This is called a “diffused dither matrix”.

Then using the diffused dither matrix, a background portion and latent image portion, with respect to the plurality of input grayscale values, are printed by a printer, and the output density is measured by a colorimeter. Based on the measurement result of this output density, thresholds are corrected so as to be ideal output density characteristics, such as linear characteristics, with respect to the input grayscale 0 to 255. This correction is the same correction which is normally performed in the calibration step of the screen gamma table. As a result, a corrected and diffused dither matrix is generated.

Finally, the thresholds of the corrected and diffused dither matrix are multiplied by 15/100 so that the maximum value becomes about 15% of the maximum output density, whereby the low density area expanded dither matrices 33 and 34 are generated. In other words, if screen processing is performed using a low density area expanded dither matrix, the output density characteristics, where the output density increases to about 15% at maximum with respect to the input grayscale 0 to 255, are implemented.

In the case of the low density area expanded dither matrix 33 of the latent image portion in FIG. 10, a threshold 1 to 7 is assigned to elements at positions of the displacement vectors (−8, 8) and (8, 8), and a threshold 8 to 254 is assigned to peripheral gray elements thereof. In other words, the black and gray pixels correspond to the maximum size of the first dot D1. The threshold 255 is assigned to other elements. In this case, a dot is generated in pixels of which threshold is less than the input grayscale if the input grayscale is 0 to 254, but the dots of pixels of which threshold is the input grayscale 255 are controlled to be OFF. Or the input grayscale 255 is inhibited in the background portion.

Therefore, by using the low density area expanded dither matrix 33 of the latent image portion, in the image of the latent image portion, the first dot D1 changes from being at the minimum size of an element at positions of the displacement vectors (−8, 8) and (8, 8), to being at the maximum size of the black and gray elements with respect to the input grayscale 0 to 255. Since the output density when the first dot D1 is at the maximum size is 15% solid black, the output density changes in a 0 to 15% range with respect to the input grayscale 0 to 255. Therefore many grayscales (254 grayscales) exist in the output density 0 to 15% range.

In the latent image portion basic dither matrix DM-LI in FIG. 7B, the thresholds 1 to 31 are assigned to the elements where the first dot D1 at the maximum size is generated. Whereas in the low density area expanded dither matrix 33 in the latent image portion in FIG. 10, the thresholds 1 to 254 are assigned to the elements where the first dot D1 at the maximum size is generated. In other words, the number of grayscales (resolution) of the output density is far more than the case in FIG. 7B. This means that resolution in the density adjustment is high, and the output density of the latent image portion can be adjusted to be the same output density of the background portion at high precision.

In the low density area expanded dither matrix 34 of the background portion in FIG. 11, the thresholds 1 to 254 are dispersed in the elements at positions of the displacement vectors (−2, 2) and (2, 2), and the threshold 255 is assigned to other elements. In this case as well, a dot is generated in pixels of which threshold is less than the input grayscale with respect to the input grayscales 0 to 254, but the dots of the pixel of which threshold is the input grayscale 255 is controlled to be OFF. Or the input grayscale 255 is inhibited in the background portion.

If the low density area expanded dither matrix 34 of the background portion is used, micro dots D2 are sequentially generated only in pixels at the positions of the displacement vectors (−2, 2) and (2, 2) for the input grayscale values 0 to 255, and dots are not generated for other pixels. Therefore the image of the background portion has only the micro dots D2 dispersed at positions of a screen ruling of 212 lpi, and other dots are not generated. The output density, when micro dots D2 are generated in all pixels at the positions of the displacement vectors (−2, 2) and (2, 2), is about 12% solid black. In other words, the output density of the low density area expanded dither matrix 34 of the background portion increases or decreases within roughly a 0 to 12% range with respect to the input grayscales 0 to 255. As a result, a stable arrangement of micro dots, with which characteristics of the background portion can be exhibited the most, is guaranteed.

FIG. 12 shows the output density characteristics of the low density area expanded dither matrices 33 and 34 in FIG. 10 and FIG. 11 with respect to the input grayscale values. As mentioned above, the output density characteristics of the background portion dither matrix 34, with respect to the input grayscale value, is that the output density is roughly within a 0 to 12% range with respect to the input grayscales 0 to 255. The output density characteristics of the latent image portion dither matrix 33, with respect to the image grayscale value, is that the output density is in a 0 to 15% range with respect to the input grayscales 0 to 255. In both cases, the output density simply increases, with respect to the input grayscale value, that is, in a linear relationship, because of calibration.

The above is a description on the background portion and latent image portion dither matrices 33 and 34 according to the present embodiment.

### [Tint Block Image Data Generation Method]

Now a method for generating the tint block image data with a multi-grayscale camouflage pattern according to the present embodiment will be described.

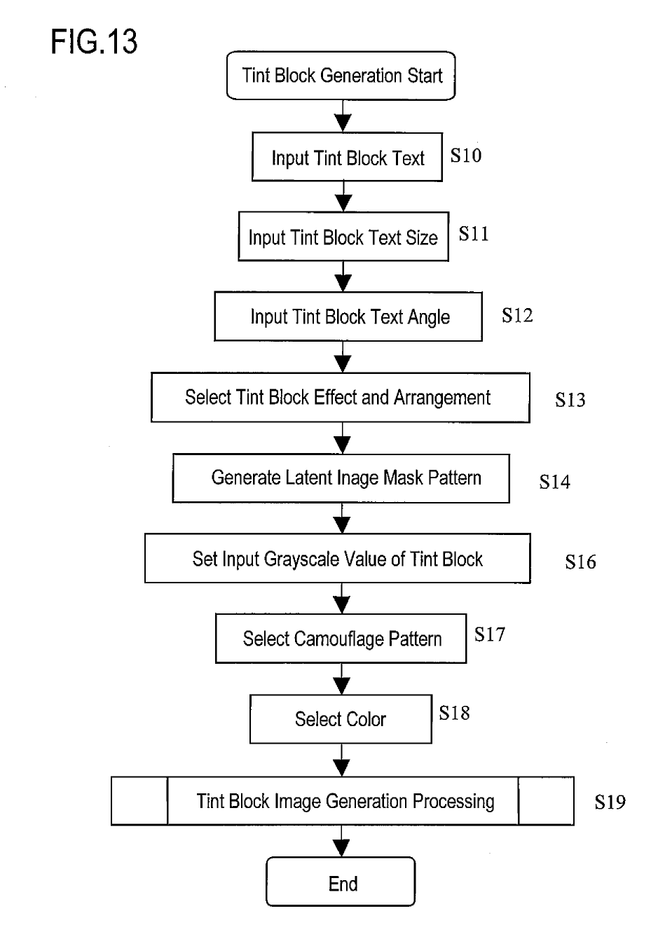

FIG. 13 is a flow chart depicting the tint block image data generation method according to the present embodiment. In the printer driver 32 of the host computer 30, the printer user selects the tint block generation menu, and executes the generation of tint block image data according to the flow chart in FIG. 13.

If the user generates an original latent image mask pattern, the user inputs the text of the tint block (S10). For example, the text “COPIED”, “DUPLICATE” or “CONFIDENTIAL” and this text becomes the latent image of the tint block. Also the size of the tint block text, such as 48 point, is input (S11), an angle of the tint block text, such as 40 degrees, is input (S12), and the tint block effect and the arrangement are selected (S13). The tint block effect is twofold: the text is either void (text is white and surrounding is block) or embossed (text is black and surrounding is white). In the case of void, the text becomes the background portion, and the surrounding becomes the latent image portion, and in the case of embossed, the text becomes the latent image portion and the surrounding becomes the background portion. The arrangement of the tint block is square, oblique and inverted, for example.

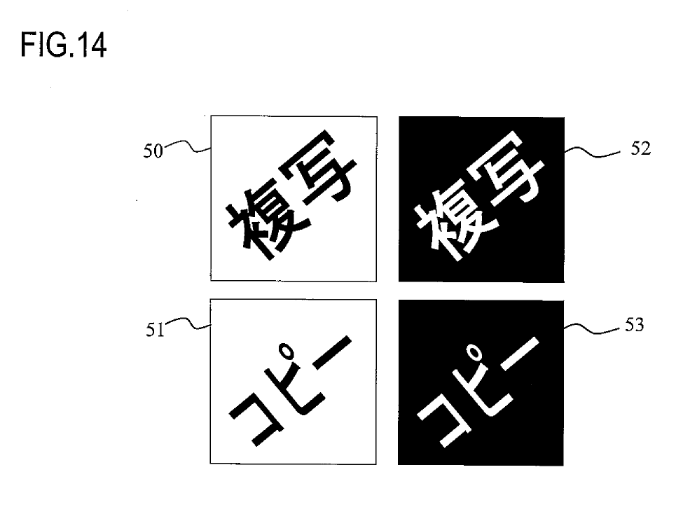

FIG. 14 shows an example of the tint block effect. The tint block patterns 50 and 51 are the text COPIED and DUPLICATE, the text is embossed in the original or in the copy thereof. The tint block patterns 52 and 53 are the same above text, but are examples of the tint block effect when the text is void in the original or in the copy. In both cases, the angle of the text is set to 40 degrees.

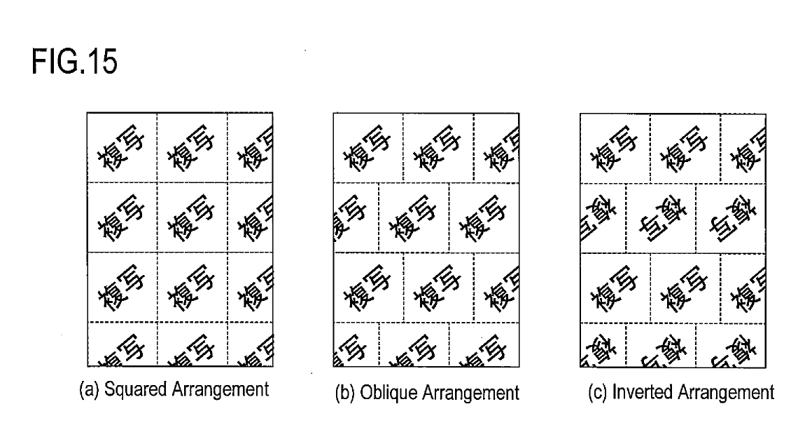

FIG. 15 shows examples of the arrangement of a tint block. In all these cases, the text is COPIED, the angle is 40 degrees, and the tint block effect is embossed. In the case of (a) square arrangement, the tint block image is generated so that the latent image mask pattern is attached like a tile. In the case of (b), an oblique arrangement, the latent image mask pattern is shifted by a predetermined phase at every line feed. And in the case of (c), an inverted arrangement, the latent image mask pattern is vertically inverted at every line feed.

When the user finishes input or selection in steps S10 to S13, the printer driver 32 generates a latent image mask pattern (S14). An example of the latent image mask pattern is a 1-bit data, where the latent image portion area and background portion area can be distinguished, as shown in FIG. 14.

If the user uses a default latent image mask pattern, S10 to S14 are omitted, and the latent image mask pattern by the user is selected. Then the printer driver 32 sets the input grayscale value of the tint block (S16). If the latent image portion dither matrix 33 and background dither matrix 34 shown in FIG. 10 and FIG. 11 are used, the maximum value of “255” is selected as the input grayscale value for the background portion, and the input grayscale value In=170, which matches the output density of the background portion (12% of solid black), is selected for the latent image portion. In other words, in the background portion, where the input grayscale value is set to “255”, the micro dot D2 is generated in all the black pixels at positions of the displacement vectors (−2, 2) and (2, 2) of the background portion dither matrix 34 (FIG. 11). The output density in this case is 12% of solid black, and a maximum number of dispersed second micro dots are generated, which is the optimum as a tint block image. In the latent image portion, where the input grayscale value is set to In=170, on the other hand, a number of dots corresponding to In=170 are generated in a half tone area comprised of pixels corresponding to the black elements and gray elements of the latent image portion dither matrix 33 (FIG. 10). As a result, the large dot D1 having a size corresponding to the input grayscale value In=170 is generated.

As the output density characteristics in FIG. 12 show, in the latent image portion dither matrix 33 and background portion dither matrix 34 in FIG. 10 and FIG. 11, the output density characteristics with respect to the input grayscale are different. In other words, the inclination of the output density with respect to the input grayscale is greater in the latent image portion dither matrix than in the background portion dither matrix. Therefore if the input grayscale “255”, whereby an optimum output image can be reproduced in the background portion, is selected, the input grayscale In=170, of which the output density matches with the output density of the background portion, is selected in the latent image portion.

The printer driver 32 acquires the camouflage pattern data according to the selection request from the user (S17). The camouflage pattern data is stored in a memory of the host computer or external memory, and the printer driver acquires the camouflage pattern according to the selection request from the user.

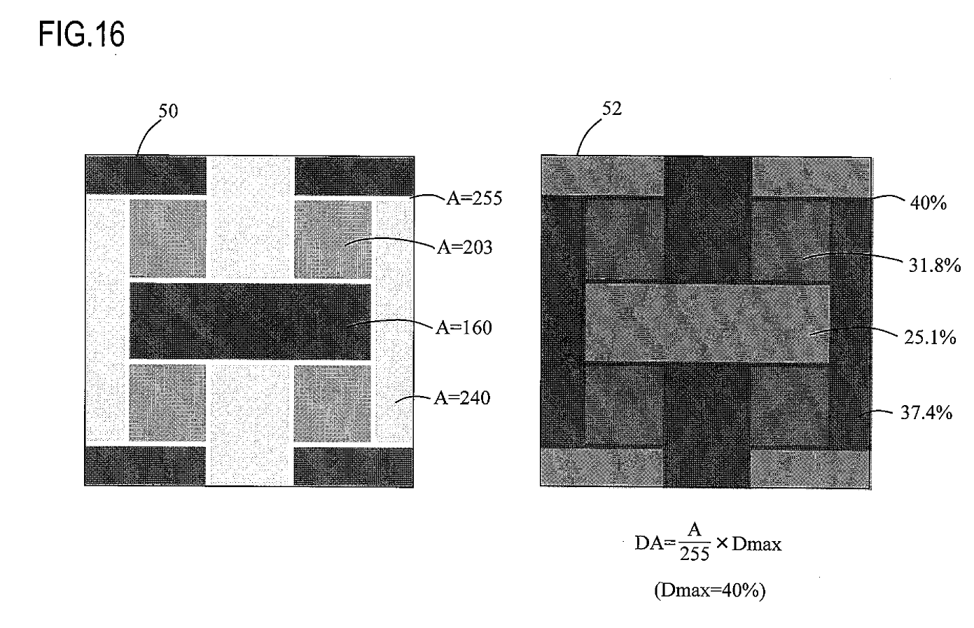

FIG. 16 shows an example of a camouflage pattern and an example of a tint block image generated by using this pattern. The camouflage pattern 50 is comprised of a plurality of rectangular areas, and the grayscale value A of each rectangular area is as shown in FIG. 16. The tint block image 52 is a tint block generated by selecting this multi-grayscale camouflage pattern. In this tint block image 52, the output density Dmax of the tint block image (e.g. Dmax=40%) is multiplied by A/255 according to the above mentioned Expression (1). In this way, in a darker area of the camouflage pattern, the output density of the tint block image drops more, and in a lighter area of the camouflage pattern, the output density of the tint block image drops less.

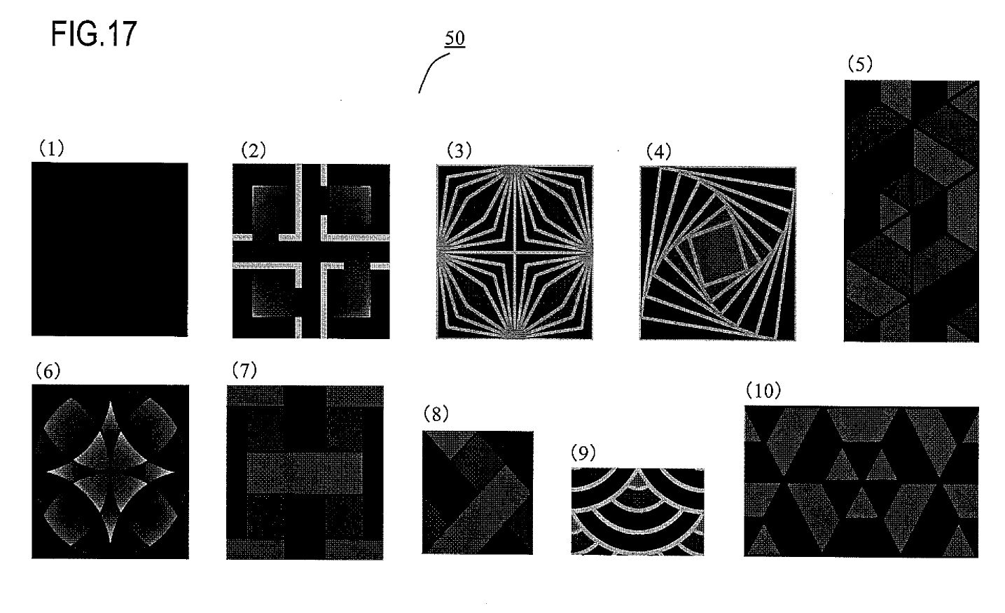

FIG. 17 shows examples of the camouflage pattern stored in a memory. FIG. 17 shows ten kinds of camouflage patterns. (1), however, is solid black (grayscale=0), so if this camouflage pattern is used, the tint block image becomes solid white.

Grayscale value A of the camouflage pattern is gray data, as mentioned above. If the camouflage pattern is RGB color image data, the grayscale value A is determined by the following Expression (2).

A=0.3×R+0.59×G+0.11B (2)

As a result of defining the grayscale values of the camouflage pattern data using black “0” and white “255”, the camouflage pattern image generated by the camouflage pattern data and the camouflage pattern image reflected in the tint block are images in which black/white are inverted. In order to allow the user to select the camouflage pattern in a state reflected on the tint block, it is preferable that the printer driver 32 displays a white/black inverted camouflage pattern image on the select screen. The grayscale value K of the image data of the white/black inverted image is determined by the following Expression (3).

K=255−A (3)

Then the printer driver 32 selects a color of the tint block (e.g. black, cyan, magenta) (S18) according to the selection request of the user. It is desirable that the color of the tint block is a single color. The grayscale values of the camouflage pattern data are therefore the grayscale value K generated from the grayscale values A of the gray data, as mentioned above, according to the equation (3). The reason is a difference between RGB of additive color mixture and CMYK of subtractive color mixture.

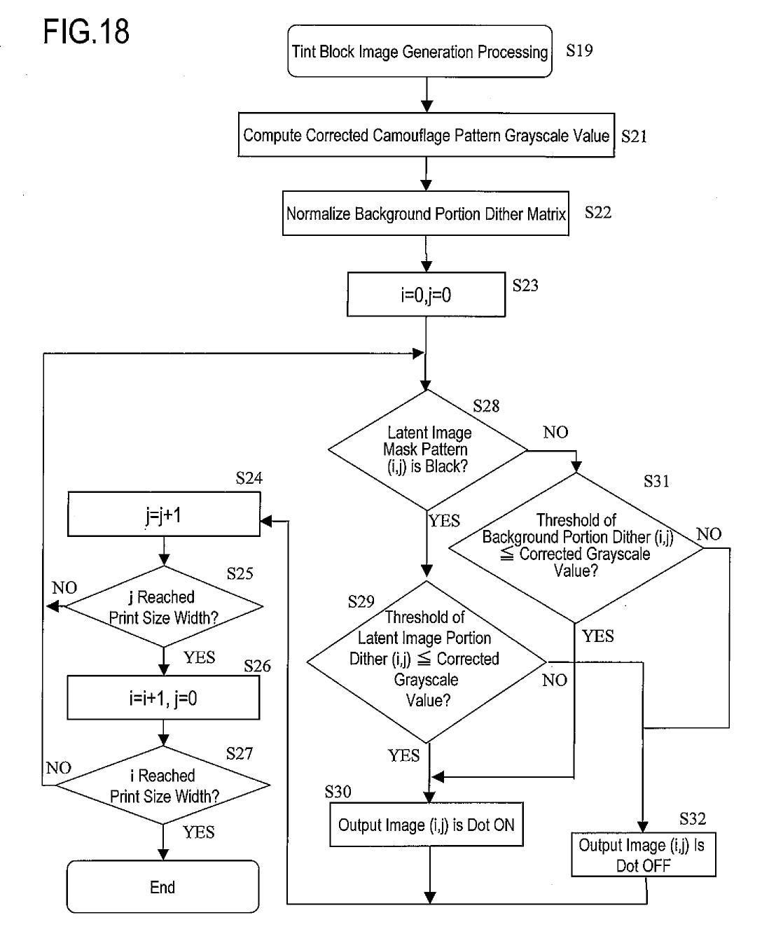

When S10 to S17, including input by the user, ends, the printer driver 32 executes the tint block image generation processing (S19). The tint block image generation processing is performed according to the flow chart in FIG. 18.

FIG. 18 is a flow chart of the tint block image generation processing according to the present embodiment. In other words, the tint block image generation processing S19 in FIG. 13 is shown in the flow chart in FIG. 18. First the grayscale values of the camouflage pattern data are corrected based on the input grayscale values of the latent image portion and background portion, so as to generate the corrected camouflage pattern data (S21). This procedure corresponds to the procedure S3 in FIG. 6.

If grayscale values of the camouflage pattern are A (0≦A≦255), and the input grayscales of the latent image portion and background portion constituting the tint block are In (1≦In≦254), The grayscale value A is converted to the grayscale value K. And the grayscale value Ki of the corrected camouflage pattern is computed by the following Expression (4).

Ki(K/255)×In (4)

This expression corresponds to the above mentioned Expression (1).

In step S16 to set the input grayscale values of the tint block image in FIG. 13, the input grayscale was set to “255” in the background portion, and the input grayscale was set to In=170 in the latent image portion. If different input grayscales are set for the background portion and the latent image portion in this way, input grayscales In to be modulated must be different between the latent image portion and background portion according to the latent image mask pattern, when the corrected camouflage pattern grayscale data is computed by Expression (4). This is because the latent image portion dither matrix 33 and background portion dither matrix 34 have different output density characteristics as shown in FIG. 12.

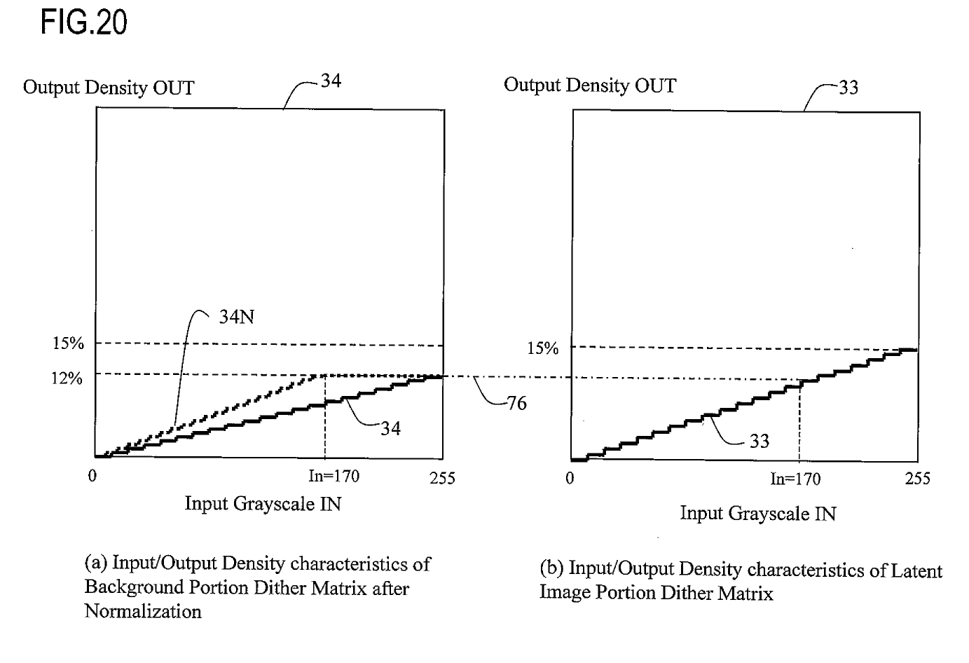

Therefore according to the present embodiment, a common input grayscale In=170 is used for both the latent image portion and background portion to simplify the computation. However, the background portion dither matrix 34 is normalized so that the maximum output density (12%) is implemented when the input grayscale is In=170 (e.g. FIG. 20), and screen processing is performed referring to the normalized background portion dither matrix.

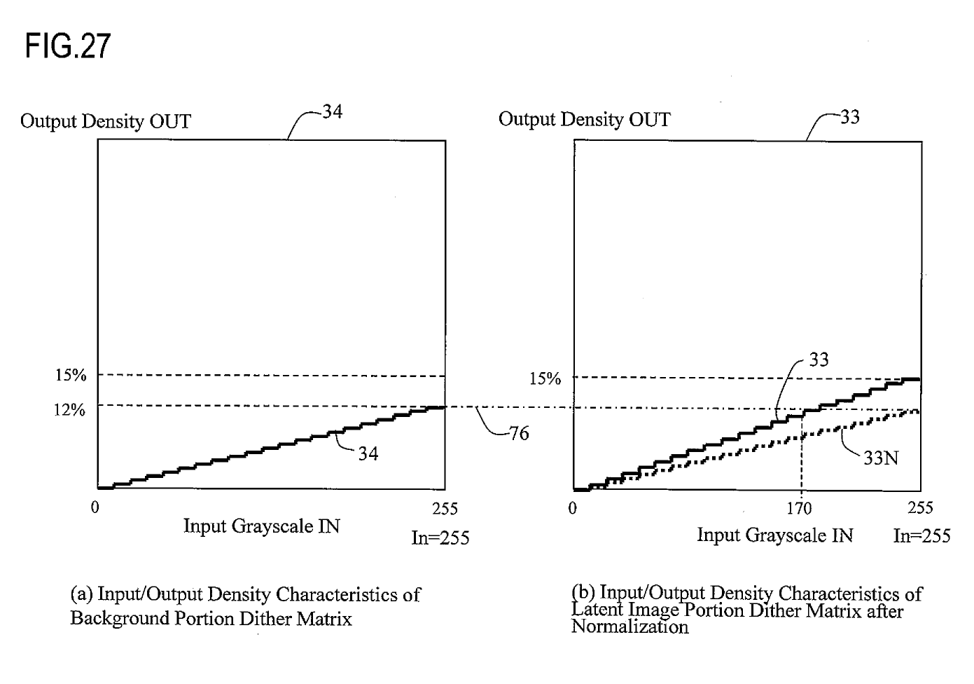

Or, as in the later mentioned variant form of the present embodiment (FIG. 27), the input grayscales are set to the maximum value of the possible grayscale values (e.g. 255) for both the latent image portion and background portion, and the latent image portion dither matrix 33 is normalized so that the output density (12%) corresponding to the input grayscale value In=170 is implemented at the input grayscale value “255”. In other words, the characteristics of the input grayscale values 0 to 170 of the latent image portion dither matrix and output densities thereof in FIG. 10 and FIG. 12 are normalized by the input grayscale value 0 to 255.

Now the case when the input grayscale In=170 is set will be described. In step S21, the grayscale value data of the corrected camouflage pattern, when the input grayscale In=170, is computed based on Expression (4). Then the printer driver 32 normalizes the background portion dither matrix 34 in FIG. 11 and FIG. 12 so as to generate the normalized background portion dither matrix shown in FIG. 20 (S22).

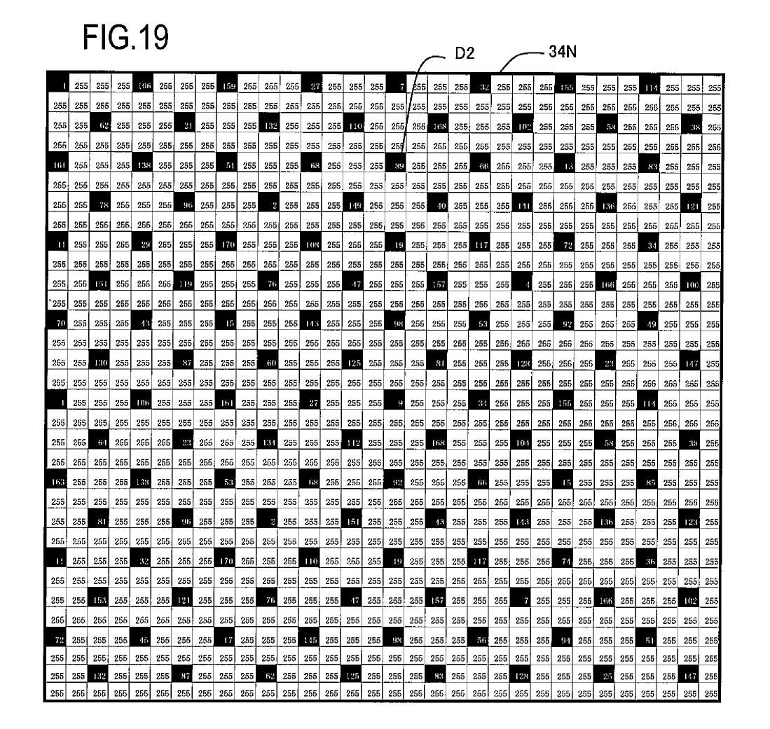

FIG. 19 shows the normalized background portion dither matrix 34N. The thresholds 0 to 254 in the black pixels at the positions of the displacement vectors (−2, 2) and (2, 2) of the background portion dither matrix 34 in FIG. 11 are normalized to new thresholds 0 to 170 (=In) using the following Expression (5).

Normalized threshold=(threshold/254)×In (5)

Therefore in the normalized background portion dither matrix 34N in FIG. 19, the thresholds in the black pixels are replaced with 0 to 170, and a dot is generated in all the black pixels and the output density becomes the maximum output density (12% of solid black) when the input grayscale value is “170”.

FIG. 20 shows the input/output density characteristics of the normalized background portion dither matrix, the background portion dither matrix before normalization, and the latent image portion dither matrix. The output density characteristics of the background portion dither matrix 34 and the latent image portion dither matrix 33 are the same as FIG. 12. In the above mentioned example, the input grayscale “255”, to generate a dot in all the pixels corresponding to the elements on the displacement vectors, is used for the background portion, and the input grayscale value In=170, which can generate the same output density as the background portion, is used for the latent image portion. Therefore, in order to use the input grayscale value In=170 for the background portion as well, the background portion dither matrix 34 is normalized with the input grayscale value In=170 so as to generate the normalized background portion dither matrix 34N shown by the characteristics of the broken line 34N in FIG. 20. The normalized background portion dither matrix 34N can be easily computed using the above mentioned Expression (5).

The input grayscale value In of the latent image portion may fluctuate due to age deterioration of the engine. By generating the normalized background portion dither matrix 34N using the input grayscale value In when fluctuation occurs, age deterioration can be absorbed.

Back in FIG. 18, tint block image data with a camouflage pattern is generated for the corrected camouflage pattern grayscale data with reference to the latent image portion dither matrix 33 or normalized background portion dither matrix 34N, according to the latent image mask pattern (S23 to S27). This tint block image data with a camouflage pattern is image data which indicates whether a dot exists or not for each pixel.

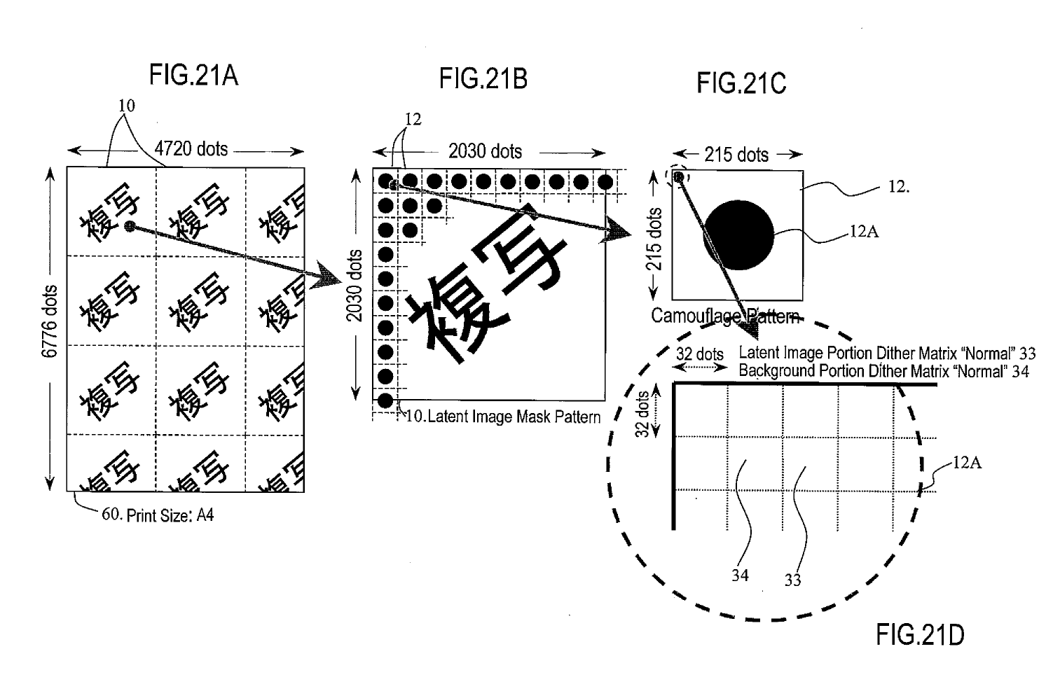

FIG. 21 is a diagram depicting the tint block image generation processing in FIG. 18. FIG. 21A shows a tint block image where a plurality of latent image mask patterns 10 are arranged in a square in an A4 print size 60. In the case of the pixels in an A4 size, there are 4720 dots in the horizontal direction and 6776 dots in the vertical direction. FIG. 21B shows the positional relationship of the latent image mask pattern 10 at the upper left of FIG. 21A and the camouflage pattern 12 arranged as tiles. The latent image mask pattern 10 is a square pattern having 2030 dots of pixels in the horizontal direction and 2030 dots of pixels in the vertical direction. The camouflage pattern 12, on the other hand, is a square pattern having 215 dots of pixels in the horizontal direction, and 215 dots of pixels in the vertical direction, as shown in FIG. 21C.

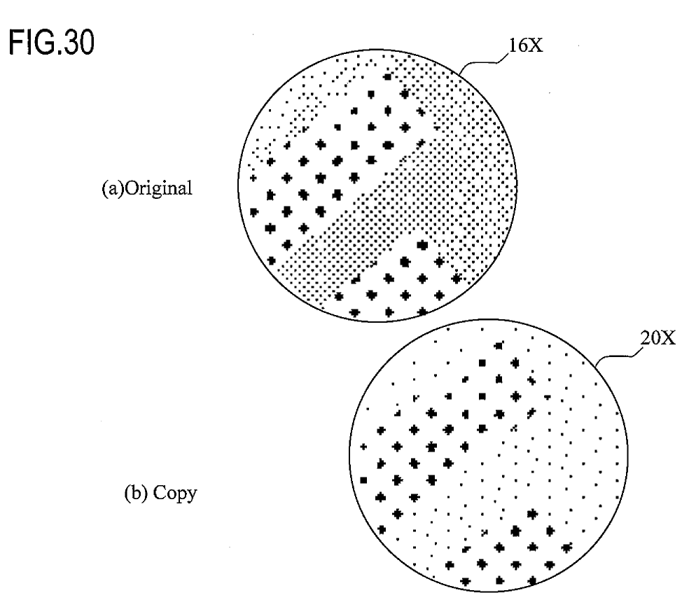

FIG. 21D is an enlarged view of the upper left edge of FIG. 30C. The latent image portion dither matrix 33-4 and the background portion dither matrix 34-5 are both 32 cells×32 cells matrices, and each cell is pasted like a tile sequentially from the upper left. Since the dither matrices 33-4 and 34-5 of the latent image portion and the background portion have the same matrix size, the correspondence relationship with pixels match perfectly, as shown in FIG. 21D.

The printer driver compares the grayscale values of the corrected camouflage pattern and the thresholds of the dither matrices 33-4 and 33-5, and if the grayscale value is the threshold or more, the pixel dot is set to ON, and if the grayscale value is less than the threshold, the pixel dot is set to OFF. The grayscale values of the corrected camouflage pattern are set only in a 0 to 254 range. Or if the input grayscale value is 255, such pixels dots are all set to OFF. The comparison target dither matrix is selected corresponding to black or white of the latent image mask pattern.

According to the flow chart in FIG. 18, the tint block image generation processing will be described. The indices i and j of the pixels of the tint block image are initialized to i=0 and j=0 respectively (S23). Then if the mask pattern at pixel (i, j) is black (YES in S28), the threshold of a corresponding pixel of the latent image portion dither matrix 33 and the corrected camouflage pattern grayscale value Ki are compared (S29), and if the latent image portion mask pattern is not black (NO in S28), the threshold of a corresponding pixel of the normalized background portion dither matrix 34N and the corrected grayscale value In are compared (S31). In both comparisons, the tint block image data (i, j) becomes dot ON if the corrected grayscale value Ki is the threshold or more (S30), and the tint block image data (i, j) becomes dot OFF if the corrected grayscale value Ki is less than the threshold (S32).

By this, the first dots (half tone) having a size corresponding to the corrected camouflage pattern grayscale value Ki are generated in the latent image portion, and a number of second dots corresponding to the corrected grayscale value Ki are generated in pixels in the corresponding positions in the background portion.

When the above processing completes, the index j in the row direction of the pixels is incremented (j=j+1) (S24), and the same processing is repeated until the index j reaches the print size width (S25). When the index j reaches the print size width (YES in S25), the index i in the column direction is incremented (i=i+1), and the index j in the row direction is reset to 0 (S26), and the same processing is repeated. When the index i in the column direction reaches the print size height (YES in S27), one page of tint block image generation processing completes. In this way, the processing target pixels are processed from the upper left in the raster scan direction, and each pixel is set to dot ON or OFF.

By the above processing, the tint block data reflecting the multi-grayscale camouflage pattern is generated.

The tine block image generated in this way becomes the tint block image data where each pixel is set to either dot ON or OFF.

The generated tint block image data and the print target image data 36 are combined as follows.

After the print target image data is converted from the RGB bit map data having RGB grayscale values into CMYK bit map data having printer colors, the tint block image is combined with the bit map data having a color of the tint block specified by the user (one of cyan, magenta and black, in the case of this example), out of the CMYK bit map data of the print target image data.

In this combining method, the dot ON data of the tint block image is converted into the grayscale value corresponding to the maximum density of the above mentioned bit map data, and the dot OFF data is converted into the grayscale value corresponding to the minimum density “0” of the bit map data. In the printer, if the values of RGB are 8-bit grayscale values respectively, then the grayscale value corresponding to the maximum density is “255”, and the grayscale value corresponding to the minimum density is “0”. This tint block image data converted into the maximum grayscale value or the minimum grayscale value is overwritten by the grayscale data of the pixels having a grayscale value greater than the grayscale value “0” in the bit map data of the specified tint block color of the print target image data. By this, the tint block image is formed in the pixels having the grayscale value “0” in the print target image, and the print target image is generated in other pixels.

Another combining method is overwriting the tint block image data on the bit map data with the specified tint block color of the print target image data. For example, if the print target image data is data to generated a black character, the CMY bit map data has the grayscale value “0” in all the pixels. Therefore the bit map data with the specified tint block color, out of CMY, does not have information of the print target image data, so all bit map data having this color is replaced with the tint block image data.

The combining method is not limited to the above mentioned overwriting, but may blend the print target image and the tint block image at a predetermined ratio based on the type of image (e.g. text, image, graphic) and the grayscale value of each pixel of the print target image data. The tint block data may be overwritten only on a portion where the grayscale value of the print target data is “0” for all of CMYK out of the bit map data having the specified tint block color, that is, a portion where an image is not formed on the print medium based on the print target image data.

The combined image data is printed on the print medium via ordinary binary processing (screen processing) of a printer.

Out of the combined image data, the portion comprised of only the tint block image is comprised of pixels having the maximum density grayscale value and the minimum grayscale value, so regardless what the threshold matrix of the screen processing is like, the grayscale is converted such that the density value of the portion having the maximum density “255” remains as this density value, and the portion having the minimum density “0” remains as density “0” even after screen processing. As a result, the tint block image generated in the tint block generation processing is printed on the print medium.

### EXAMPLES

The generation of the tint block image with a multi-grayscale camouflage pattern according to the present embodiment will be described using examples.

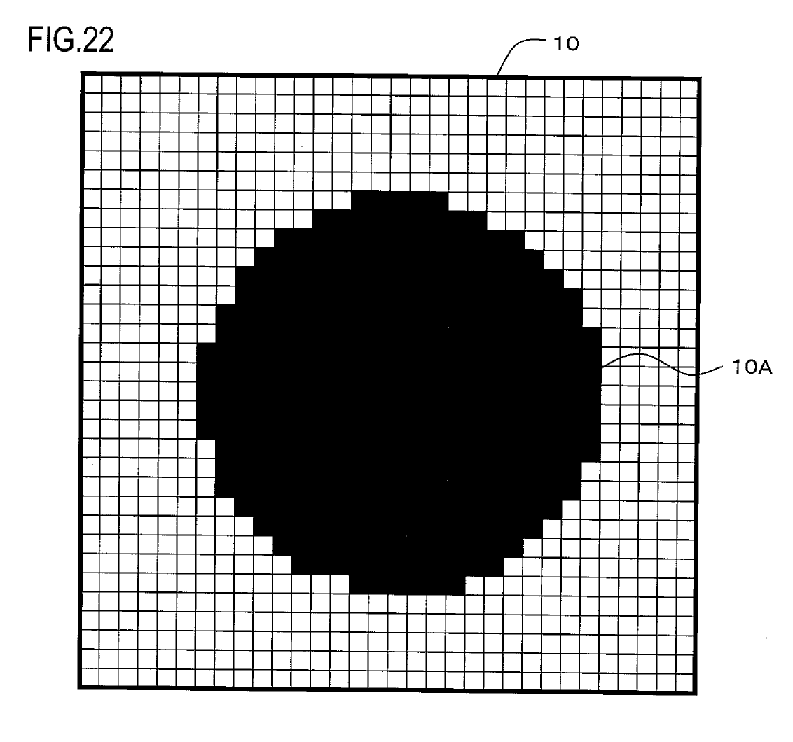

FIG. 22 shows an example of a latent image mask pattern. A latent image mask pattern 10 is generated in a 32×32 matrix. The pattern 10A corresponds to the latent image portion, and an area other than the pattern 10A corresponds to the background portion. This means that the matrix data of this latent image mask pattern has 1 bit, “0” (latent image pattern) or “1” (background portion), in each pixel of the 32×32 matrix.

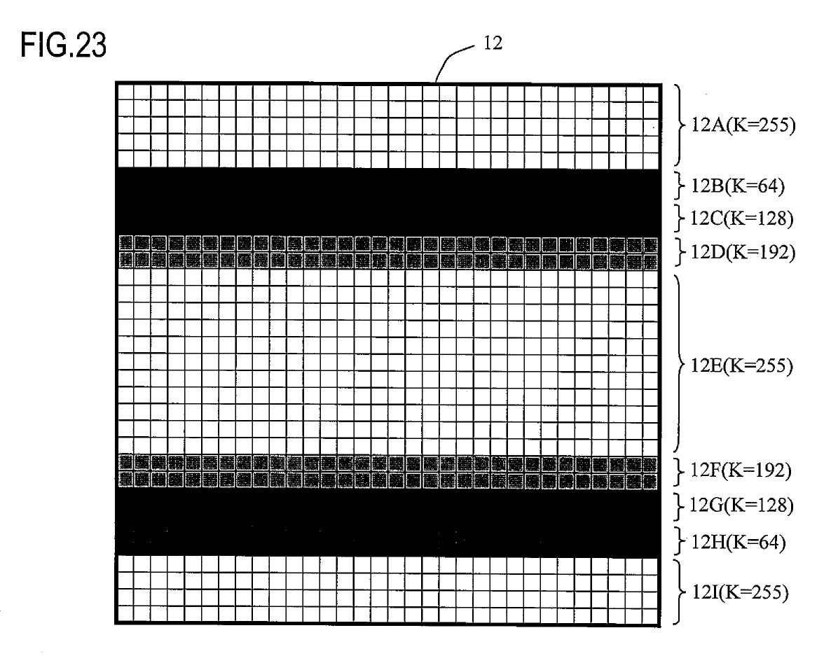

FIG. 23 shows an example of a camouflage pattern. In this camouflage pattern 12, the pixels in the 32×32 matrix have nine strip areas 12A to 12I. A threshold A of each area 12A to 121 is shown in FIG. 23. In other words, the areas 12A, 12E and 12I are white areas of which grayscale value is “255”, and areas 12B and 12H are areas closest to black, of which grayscale value is “64”.

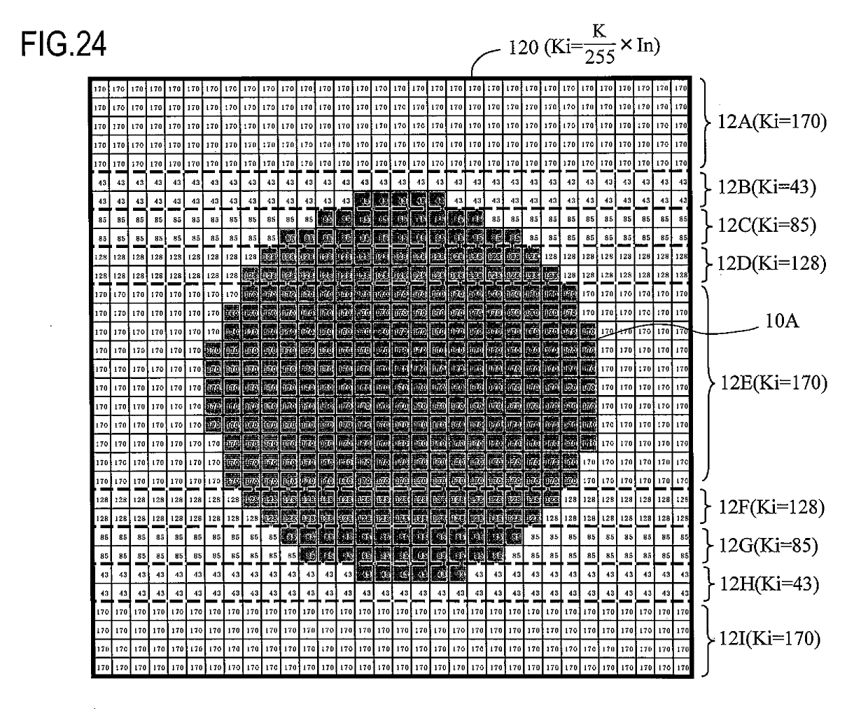

FIG. 24 shows an example of corrected camouflage pattern grayscale values. The corrected camouflage pattern grayscale value data 120 is determined by the above mentioned Expression (4). This example shows the grayscale value data acquired by correcting the camouflage pattern in FIG. 23 based on the input grayscale value In=170 of the tint block image. In FIG. 24, the latent image mask pattern 10A is shown by gray, and the camouflage pattern areas 12A to 12I are shown by the broken lines. The grayscale values Ki of the camouflage pattern, corresponding to the grayscale values A of the camouflage pattern in FIG. 23 are shown in FIG. 24.

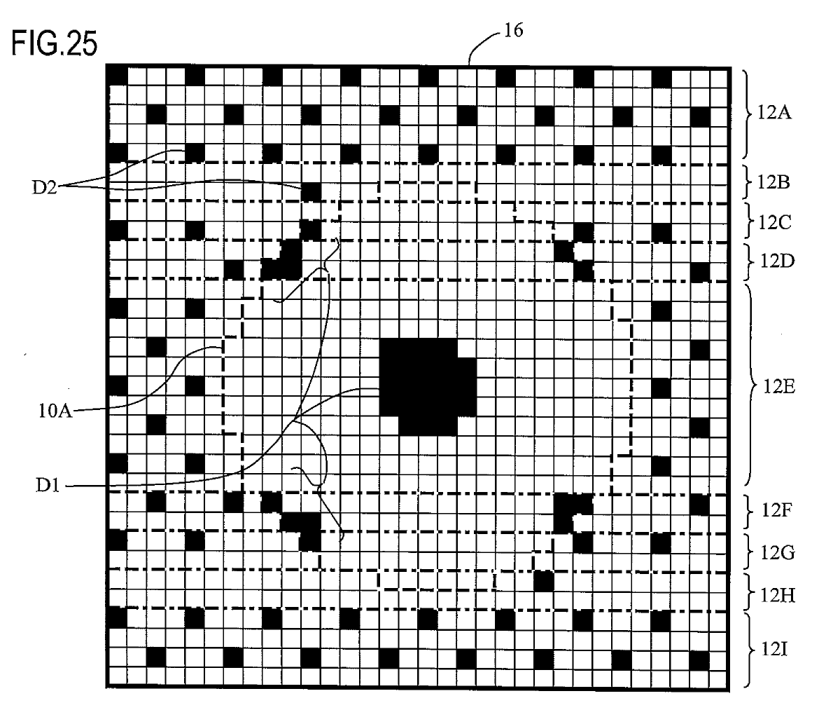

FIG. 25 shows an example of a tint block image with a camouflage pattern. This is a tint block image 16 generated by performing screen processing on the grayscale values Ki of the corrected camouflage pattern shown in FIG. 24, referring to the latent image portion dither matrix 33 and the normalized background portion dither matrix 34N in FIG. 10, FIG. 19 and FIG. 20. In FIG. 25, the camouflage pattern areas 12A to 12I are indicated by the dash and dot lines, and the latent image mask pattern 10A is indicated by the broken lines.

In the latent image mask pattern 10A, the first dots D1 corresponding to the corrected grayscale Ki=170 are formed in the area 12E, and the first dots D1 corresponding to the corrected grayscale Ki=128 and 85 are formed in the areas 12D, 12C, 12F and 12G. Outside the latent image mask pattern 10A, the second dots D2 corresponding to the corrected grayscale Ki=170 are formed on all the displacement vectors in the area 12A, and the second dots D2 corresponding to the respective corrected grayscale Ki=43, 85, 128, 128, 85 and 43 are formed in the other areas 12B, 12C, 12D, 12F, 12G and 12H.

As the tint block image in FIG. 25 shows, dots in density or size corresponding to the grayscale values of the camouflage pattern are formed in the tint block image by using a multi-grayscale camouflage pattern.

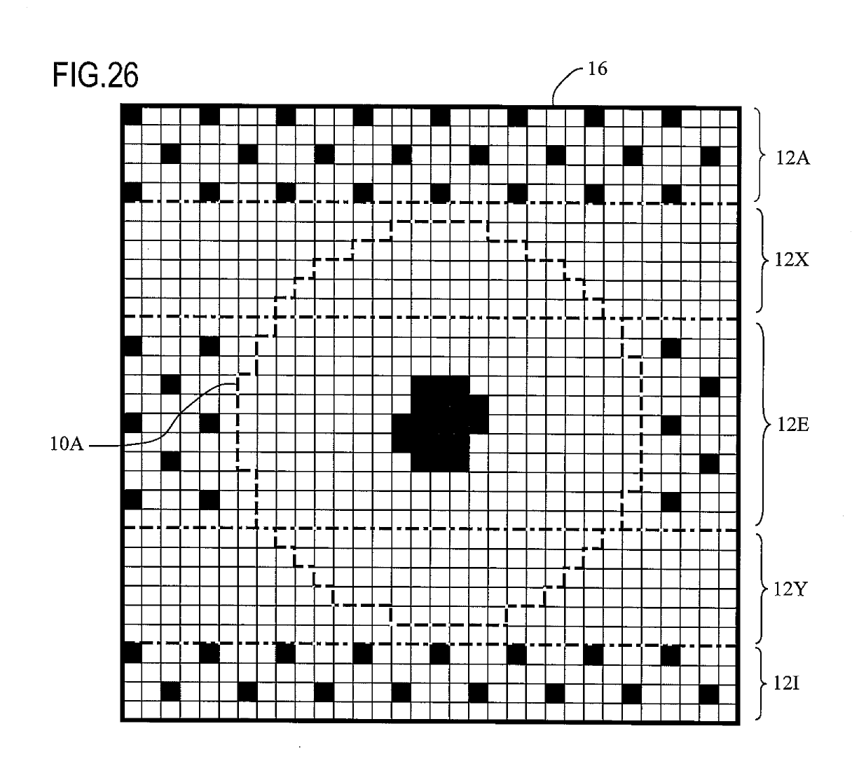

FIG. 26 shows an example of the tint block image in the case of a conventional two-grayscale camouflage pattern. A conventional two-grayscale camouflage pattern only has areas 12A, 12E and 121 where dots exist, and areas 12X and 12Y where dots do not exist. In other words, halftone areas 12B, 12C, 12D, 12F, 12G and 12H do not exist. Therefore no dots are formed in areas 12X and 12Y.

### [Variant Form]

FIG. 27 shows the input/output density characteristics of the background dither matrix and the normalized latent image portion dither matrix according to a variant form of the present embodiment. In the above mentioned embodiment, the screen processing is performed referring to the normalized background portion dither matrix 34N and the latent image portion dither matrix 33 shown in FIG. 20. In FIG. 27, the background portion dither matrix 34 is the same as FIG. 12, but the normalized latent image portion dither matrix 33N is normalized so that the output density (12%) with respect to the input grayscale value “170” becomes the output density with respect to the maximum input grayscale value “255”.

For normalization, the following Expressions (6) and (7) are used.

Normalization threshold=(threshold/In)×254(1≦threshold≦In) (6)

Normalization threshold=255(if In<threshold) (7)

In other words, the thresholds 1 to In (=170) in the latent image portion dither matrix 33 in FIG. 10 are converted into the normalized thresholds 1 to 254, and the thresholds In to 254 are converted into the normalized threshold “255”. Thereby the image data, of which output density is in a 0 to 12% range with respect to the grayscale value Ki, is generated.

When the background portion dither matrix 34 and the normalized latent image portion dither matrix 33N in FIG. 27 are used, the input grayscale value In of the tint block image is set to In=255. In other words, the background portion and the latent image portion both become 12% output density in the tint block image. As a result, the above Expression (4), when In=255, becomes Ki=(K/255)×In=K, and the grayscale value Ki of the camouflage pattern after correction becomes the same as the grayscale value A of the camouflage pattern before correction.

In other words, the step of computing the grayscale values of the corrected camouflage pattern (S3 in FIG. 6 and S21 in FIG. 18) is not required. And the grayscale value Ki of the camouflage pattern after correction becomes one of the maximum grayscale range 0 to 255. Therefore the multi-grayscale representation of the camouflage pattern can be fully utilized.

However, it is necessary that the output density characteristics with respect to the possible input grayscale value range 0 to 255 of the latent image portion dither matrix 33N and the background portion dither matrix 34 match, and the input grayscale values In of the latent image portion and the background portion of the tint block image are the input grayscale value “255”, which is the maximum in the possible input grayscale value range of the latent image portion dither matrix and background portion dither matrix. In other words, if the latent image portion and background portion dither matrices are designed to be optimum output densities at the maximum input grayscale value In=255, as mentioned above, then the tint block image with a multi-grayscale camouflage pattern can be generated by performing halftone processing in which these dither matrices are referred to for the grayscale values of the camouflage pattern according to the latent image mask pattern.

The normalized dither matrix 34N in FIG. 20 and the normalized dither matrix 33N in FIG. 27 to be used are generated based on the engine characteristics before shipment. If the output density characteristics of the engine change by age deterioration, it is preferable to normalize the dither matrix at an appropriate timing or when the tint block image is generated.

### EXPERIMENT EXAMPLE

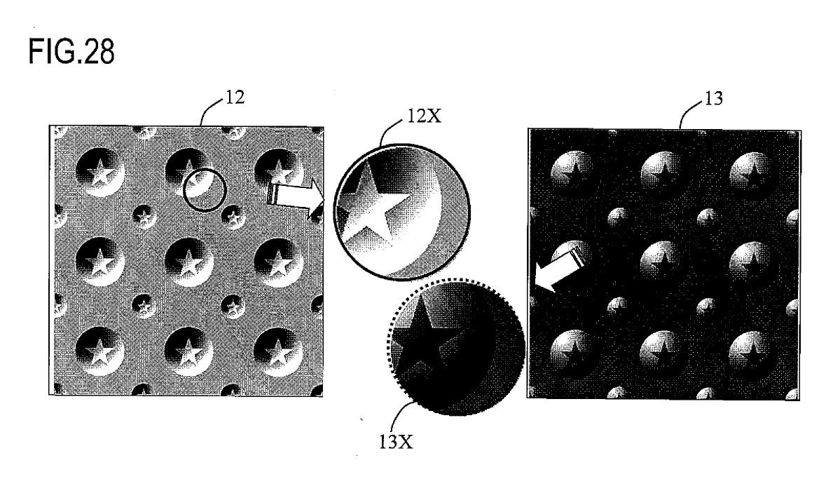

FIG. 28 shows the experiment example of the multi-grayscale camouflage pattern. This multi-grayscale camouflage pattern 12 has halftones. When this camouflage pattern 12 is reflected in the tint block image, the black/white inverted camouflage pattern 13 is generated, as mentioned above. 12X and 13X are enlarged views of the camouflage pattern 12 and the camouflage pattern 13 respectively.

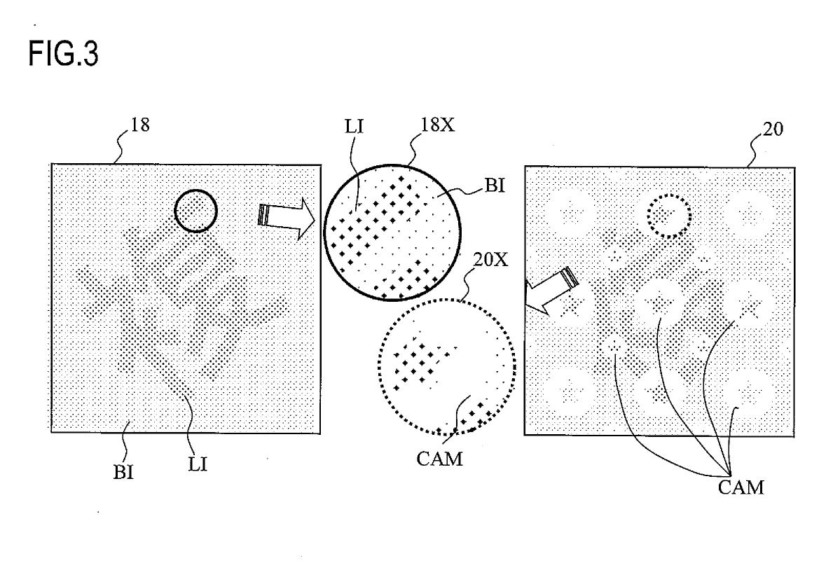

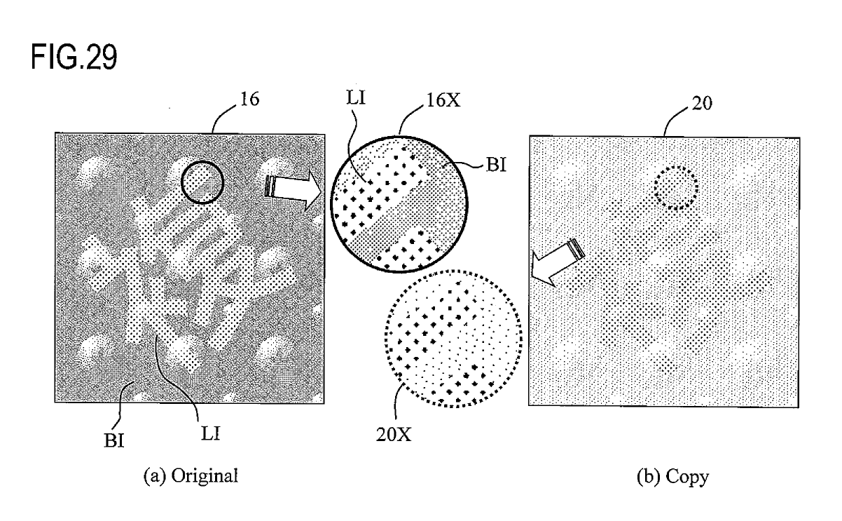

FIG. 29 shows an experiment examples of an original and a copy of the tint block image where the multi-grayscale camouflage pattern in FIG. 28 is reflected. FIG. 30 are diagrams further enlarging the enlarged views 16X and 20X thereof. As the original 16 in FIG. 29A shows, contrast is suppressed in the multi-grayscale camouflage pattern, and the discerning capability for an original print document image is not diminished very much. As the copy 20 in FIG. 29B shows, the latent image “COPY” is more accurately reproduced in the copy because of the multi-grayscale camouflage pattern, and identification capability for the latent image in the copy can be increased. By comparing this with the original 16 in FIG. 2 and the copy 20 in FIG. 3, the above mentioned effect can be more clearly understood.

As described above, according to the present embodiment, three-dimensional patterns can also be represented by using the multi-grayscale camouflage pattern, and artistic expression and flexibility of a camouflage pattern can be improved dramatically. The contrast of the camouflage pattern can be adjusted to be lower, so when a camouflage pattern is combined with a print document image, the camouflage pattern does not drop the discerning capability of original. Also in the copy of the tint block image, dots can remain corresponding to the grayscale values of the camouflage pattern, both in the latent image portion and the background portion, so the identification capability for the latent image “COPY” in the copy can be improved.

What is claimed is:

1. A computer-readable medium which stores a tint block image generation program for causing a computer to execute a tint block image generation step of generating tint block image data which forms, on a print medium, a tint block image including a latent image portion and a background portion, having different output densities to be reproduced during copying, wherein the tint block image generation step comprises:
a first step of acquiring camouflage pattern data that has multi-grayscales exceeding two grayscales;
a second step of generating corrected camouflage pattern data by correcting grayscale values of the camouflage pattern data based on input grayscale values of the latent image portion and background portion; and
a third step of generating latent image portion image data corresponding to the grayscale values of the corrected camouflage pattern data by referring to a latent image portion dither matrix in an area corresponding to the latent image portion, and generating background portion image data corresponding to the grayscale values by referring to a background portion dither matrix in an area corresponding to the background portion.

2. The computer-readable medium which stores the tint block image generation program according to claim 1, wherein the latent image portion image data and background portion image data which are generated by referring to the latent image portion dither matrix and background portion dither matrix in the third step, respectively, are image data to reproduce a multi-grayscale latent image portion image and a multi-grayscale background portion image, respectively.

3. The computer-readable medium which stores the tint block image generation program according to claim 1, wherein
the latent image portion image data is image data for forming a plurality of first dots in positions corresponding to the grayscale values of the corrected camouflage pattern data,
the background portion image data is image data for forming a plurality of second dots in positions corresponding to the grayscale values of the corrected camouflage pattern data, and
the latent image portion dither matrix is a dot-clustered dither matrix where dots are clustered in the center of the first dots, and the background portion dither matrix is a dot-dispersed dither matrix where the second dots are dispersed.

4. The computer-readable medium which stores the tint block image generation program according to claim 1, wherein
characteristics of output densities with respect to a possible range of the grayscale values match between the latent image portion dither matrix and background portion dither matrix, and
the input grayscale values of the latent image portion and background portion are the same.

5. The computer-readable medium which stores the tint block image generation program according to claim 1, wherein
the multi-grayscale camouflage pattern data has grayscale data of a plurality of colors, and
in the first step, the grayscale values of the camouflage pattern data are grayscale values which are determined based on the grayscale values of the plurality of colors.

6. The computer-readable medium which stores the tint block image generation program according to claim 1, wherein
in the first step, camouflage pattern data selected from a plurality of types of camouflage pattern data stored in a memory is acquired in response to a selection request of a user.

7. A computer-readable medium which stores a tint block image generation program for causing a computer to execute a tint block image generation step of generating tint block image data which forms, on a print medium, a tint block image including a latent image portion and a background portion, having different output densities to be reproduced during copying, wherein the tint block image generation step comprises:
a step of acquiring camouflage pattern data that has multi-grayscales exceeding two grayscales; and
a step of generating latent image portion image data corresponding to grayscale values of the camouflage pattern data by referring to a latent image portion dither matrix in an area corresponding to the latent image portion, and generating background portion image data corresponding to the grayscale values by referring to a background portion dither matrix in an area corresponding to the background portion, and wherein
characteristics of output densities with respect to a possible range of input grayscale values match between the latent image portion dither matrix and background portion dither matrix, and the grayscale values of the latent image portion and background portion are set to the maximum input grayscale value out of the possible range of the input grayscale values of the latent image portion dither matrix and background portion dither matrix.

8. The computer-readable medium which stores the tint block image generation program according to claim 7, wherein
an output density corresponding to the maximum input grayscale value of the latent image portion dither matrix and background portion dither matrix corresponds to the maximum value of the output density of the tint block image.

9. A tint block image generation device that generates, on a print medium, a tint block image including a latent image portion and a background portion, having different output densities to be reproduced during copying, the tint block image generation device comprising:
a camouflage pattern data acquisition unit which acquires camouflage pattern data that has multi-grayscales exceeding two grayscales;
a correction unit which generates corrected camouflage pattern data by correcting grayscale values of the camouflage pattern data based on input grayscale values of the latent image portion and background portion; and
a tint block image data generation unit which generates latent image portion image data corresponding to the grayscale values of the corrected camouflage pattern data by referring to a latent image portion dither matrix in an area corresponding to the latent image portion, and generates background portion image data corresponding to the grayscale values by referring to a background portion dither matrix in an area corresponding to the background portion.

10. A tint block image generation device that generates, on a print medium, a tint block image including a latent image portion and a background portion, having different output densities to be reproduced during copying, the tint block image generation device comprising:
a camouflage pattern data acquisition unit which acquires camouflage pattern data that has multi-grayscales exceeding two grayscales; and
a tint block image data generation unit which generates latent image portion image data corresponding to grayscale values of the camouflage pattern data by referring to a latent image portion dither matrix in an area corresponding to the latent image portion, and generates background portion image data corresponding to the grayscale values by referring to a background portion dither matrix in an area corresponding to the background portion, wherein
characteristics of output densities with respect to a possible range of input grayscale values match between the latent image portion dither matrix and background portion dither matrix, and the grayscale values of the latent image portion and background portion are set to the maximum input grayscale value out of the possible range of the input grayscale values of the latent image portion dither matrix and background portion dither matrix.
